(19) United States
(12) Patent Application Publication
(10) Pub. No.: US 2026/0196432 A1
(43) Pub. Date: Jul. 9, 2026

(54) RELAY

(71) Applicant: Xiamen Hongfa Electric Power Controls Co., Ltd., Xiamen, Fujian (CN)

(72) Inventors: Shuming ZHONG, Xiamen, Fujian (CN); Wenguang DAI, Xiamen, Fujian (CN); Feng HE, Xiamen, Fujian (CN); Zhongbo HE, Xiamen, Fujian (CN)

(21) Appl. No.: 19/134,618

(22) PCT Filed: Nov. 30, 2023
(86) PCT No.: PCT/CN2023/135620

§ 371 Date: May 30, 2025

(30) Foreign Application Priority Data
Dec. 1, 2022 (CN) 202211538297.8
Dec. 1, 2022 (CN) 202223233490.9
Dec. 1, 2022 (CN) 202223234194.0
Dec. 1, 2022 (CN) 202223234231.8

(51) Int. Cl. H01H 50/54; H01H 50/64

(52) U.S. Cl. CPC H01H 50/54; H01H 50/641

(57) ABSTRACT

A relay includes a base; a push rod mechanism including a push rod and an iron core, wherein the push rod includes a mounting portion connected to the rod portion and a rod portion for the iron core fixedly connected, the push rod and the iron core can move linearly relative to the base; and a contact assembly including a static contact piece and a movable contact piece, the static contact piece is fixedly connected to the base and includes a contact terminal and a lead-out terminal, the movable contact piece is mounted on the mounting portion; the lead-out terminal extends out from a bottom surface of the base and is used for electrical connection with an external circuit; a width of the lead-out terminal is smaller than a width of the contact terminal.

### CROSS-REFERENCE

The present disclosure is the U.S. national phase application of International Application No. PCT/CN/2023/135620, filed on Nov. 30, 2023, which claims priority to Chinese Patent Application No. 202211538297.8, No. 202223233490.9, No. 202223234194.0, and No. 202223234231.8, all filed on Dec. 1, 2022, each of these applications is herein incorporated by reference in its entirety.

### TECHNICAL FIELD

The embodiments of the present disclosure relate to the field of electronic control devices, and in particular, to a relay.

### BACKGROUND

A relay is an electronic control device having a control system (also called an input circuit) and a controlled system (also called an output circuit), and is typically used in automatic control circuits. In essence, a relay uses a smaller current to control a larger current, functioning as an automatic switch. Therefore, the relay plays roles such as automatic regulation, safety protection, and circuit conversion in circuits.

The operating voltage of the relay refers to the voltage applied to the coil when the contacts switch from the open state to the closed state. When the relay is a magnetic latching relay, the dropout voltage refers to the voltage applied to the coil when the contacts switch from the closed state to the open state. When the relay is a non-magnetic latching relay, the residual voltage across the coil when the contacts switch from the closed state to the open state is called the release voltage.

However, the relays in the prior art cannot effectively adjust the operating voltage. Moreover, when the relay is a magnetic latching relay, the adjustment of the operating voltage and the dropout voltage cannot be completed independently, and the flexibility of adjustment still needs to be further improved.

### SUMMARY

The relay of the embodiments of the present disclosure, including:
a base;
a contact assembly, including a static contact piece and a movable contact piece that can come into contact with or separate from each other, the static contact piece is fixedly connected to the base;
a push rod mechanism, movable relative to the base in a contact-separation direction of the contact assembly between a first position and a second position; and
an elastic component, including a first elastic portion and a second elastic portion; the movable contact piece is disposed on the push rod mechanism through the first elastic portion, the first elastic portion is configured to provide contact pressure when the push rod mechanism is in the first position; the second elastic portion is configured to provide an elastic force for the push rod mechanism to move towards the first position when the push rod mechanism is in the second position.

According to some embodiments of the present disclosure, when the push rod mechanism is in the second position, one end of the second elastic portion abuts against the movable contact piece, and another end of the second elastic portion abuts against the base.

According to some embodiments of the present disclosure, when the push rod mechanism is in the first position, the second elastic portion does not provide an elastic force to the push rod mechanism.

According to some embodiments of the present disclosure, the relay further includes a permanent magnet;
the push rod mechanism includes a push rod and an iron core, the iron core is connected to the push rod, the permanent magnet is disposed at a side of the iron core away from the push rod.

According to some embodiments of the present disclosure, the base includes:
a bottom wall;
a side wall, connected to the bottom wall; and
a stop portion, connected to an inner surface of the side wall, for abutting against the second elastic portion; when the push rod mechanism is in the first position, the second elastic portion does not contact the stop portion.

According to some embodiments of the present disclosure, the second elastic portion includes two elastic pieces, the two elastic pieces are respectively located at both sides of the first elastic portion along a width direction of the movable contact piece;
each elastic piece has two second elastic arms at both ends along a length direction of the movable contact piece, the second elastic arms are configured to press between the movable contact piece and the base.

According to some embodiments of the present disclosure, the second elastic arm includes:
a second bend, a protrusion of the second bend is configured to abut against the movable contact piece; and
a spring strip, one end is connected to the second bend, another end is configured to abut against the base.

According to some embodiments of the present disclosure, the elastic component is fixedly connected to the movable contact piece through the first elastic portion.

According to some embodiments of the present disclosure, the first elastic portion includes:
a main piece, having connection portions at both ends along the length direction of the movable contact piece, the connection portions are fixedly connected to the movable contact piece, an opening is provided between the two connection portions; and
a first elastic arm, one end of the first elastic arm is connected to an edge of the opening, another end is configured to abut against the push rod mechanism.

According to some embodiments of the present disclosure, another end of the first elastic arm has a first bend, a protrusion of the first bend is configured to abut against the push rod mechanism.

According to some embodiments of the present disclosure, the connection portion has a connection hole, movable contacts at both ends of the movable contact piece pass through the connection hole.

According to some embodiments of the present disclosure, a plane where the opening is located is not coplanar with a plane where the connection portion is located.

According to some embodiments of the present disclosure, the push rod mechanism includes a push rod, the push rod includes a rod portion and a bottom portion, the bottom portion is connected to one end of the rod portion in an axial direction, and along the axial direction of the rod portion, the movable contact piece is movable relative to the bottom portion between a third position and a fourth position; the first elastic portion abuts against the bottom portion and the movable contact piece, providing an elastic force for the movable contact piece to move towards the third position; the elastic component is disposed between the bottom portion and the movable contact piece;
when the push rod mechanism is in the first position, the movable contact piece is in the fourth position; when the push rod mechanism is in the second position, the movable contact piece is in the third position.

According to some embodiments of the present disclosure, the push rod further includes a first side portion and a second side portion, the first side portion and the second side portion are both connected to the bottom portion, and are arranged oppositely along the length direction of the movable contact piece;
the first side portion has a first through hole, the second side portion has a second through hole, the movable contact piece and the elastic component both pass through the first through hole and the second through hole; in the third position, the movable contact piece abuts against a wall of the first through hole and a wall of the second through hole.

According to some embodiments of the present disclosure, the first elastic portion and the second elastic portion are an integral structure.

### BRIEF DESCRIPTION OF DRAWINGS

The above and other features and advantages of the present disclosure will become more apparent by describing in detail its exemplary embodiments with reference to the accompanying drawings.

FIG. 1 shows a top view of the first embodiment of the relay of the present disclosure, with the upper cover omitted and the contact assembly in a fully open state.

FIG. 2 shows a cross-sectional view along A-A of FIG. 1.

FIG. 3 shows a cross-sectional view along B-B of FIG. 2.

FIG. 4 shows a cross-sectional view of the contact assembly in a fully closed state in FIG. 1, with the push rod mechanism and magnetic circuit mechanism omitted.

FIG. 5 shows a cross-sectional view of the contact assembly in a fully open state in FIG. 1, with the push rod mechanism and magnetic circuit mechanism omitted.

FIG. 6 shows a cross-sectional view of the relay during the opening process in FIG. 1, with the second elastic portion of the elastic component just contacting the base, and with the push rod mechanism and magnetic circuit mechanism omitted.

FIG. 7 shows a perspective view of the elastic component.

FIG. 8 shows a side view of the elastic component.

FIG. 9 shows a perspective view of the push rod.

FIG. 10 shows an assembly view of the push rod, yoke plate, elastic component, and contact assembly.

FIG. 11 shows a side view of FIG. 10.

FIG. 12 shows a cross-sectional view along C-C of FIG. 11.

FIG. 13 shows a top view of the relay of the present disclosure, with the upper cover omitted and the contact assembly in a fully closed state.

FIG. 14 shows a cross-sectional view along D-D of FIG. 13.

FIG. 15 shows a cross-sectional view along E-E of FIG. 14.

FIG. 16 shows a perspective view of the contact assembly in a fully closed state in FIG. 1, with the push rod mechanism and magnetic circuit mechanism omitted.

FIG. 17 shows a perspective view of the contact assembly in a fully open state in FIG. 1, with the push rod mechanism and magnetic circuit mechanism omitted.

FIG. 18 shows a perspective view of the relay during the opening process in FIG. 1, with the second elastic portion of the elastic component just contacting the base, and with the push rod mechanism and magnetic circuit mechanism omitted.

FIG. 19 shows a top view of the second embodiment of the relay of the present disclosure, with the upper cover omitted.

FIG. 20 shows a cross-sectional view along F-F of FIG. 19.

FIG. 21 shows a cross-sectional view along G-G of FIG. 20.

FIG. 22 shows an exploded view of the static contact piece and static contact.

FIG. 23 shows an assembly view of the contact assembly and push rod.

FIG. 24 shows another view of the relay of the present disclosure, with the bottom surface of the base facing up.

FIG. 25 shows a cross-sectional view along H-H of FIG. 20.

FIG. 26 shows an enlarged view of the area X1 in FIG. 25.

FIG. 27 shows an exploded view of the push rod mechanism in the prior art.

FIG. 28 shows a cross-sectional view of the assembled push rod mechanism in the prior art.

FIG. 29 shows a top view of the third embodiment of the relay of the present disclosure, with the upper cover omitted.

FIG. 30 shows a cross-sectional view along I-I of FIG. 29.

FIG. 31 shows a cross-sectional view along J-J of FIG. 30.

FIG. 32 shows a top view of the push rod mechanism of the first embodiment of the present disclosure.

FIG. 33 shows an exploded view of FIG. 32.

FIG. 34 shows a cross-sectional view along K-K of FIG. 32.

FIG. 35 and FIG. 36 show views of the iron core from two different perspectives.

FIG. 37 and FIG. 38 show views of the second iron core from two different perspectives.

FIG. 39 shows a view of the push rod mechanism of another embodiment of the present disclosure.

FIG. 40 shows a view of the iron core in FIG. 39.

FIG. 41 shows a view of the second iron core in FIG. 39.

FIG. 42 shows a view of the push rod mechanism of another embodiment of the present disclosure.

FIG. 43 shows a view of the push rod mechanism of another embodiment of the present disclosure.

FIG. 44 shows a view of the push rod mechanism of another embodiment of the present disclosure.

FIG. 45 shows an enlarged view of the area X2 in FIG. 44.

FIG. 46 shows a cross-sectional view of the push rod mechanism of another embodiment of the present disclosure.

FIG. 47 shows an exploded view of the push rod mechanism in the prior art.

FIG. 48 shows a cross-sectional view of the assembled push rod mechanism in the prior art.

FIG. 49 shows a top view of the fourth embodiment of the relay of the present disclosure, with the upper cover omitted.

FIG. 50 shows a cross-sectional view along L-L of FIG. 49.

FIG. 51 shows a cross-sectional view along M-M of FIG. 50.

FIG. 52 shows a view of the push rod mechanism of the first embodiment of the present disclosure.

FIG. 53 shows a cross-sectional view along N-N of FIG. 52.

FIG. 54 shows an enlarged view of the area X3 in FIG. 53.

FIG. 55 shows a view of the iron core in FIG. 52.

FIG. 56 shows a view of the push rod mechanism of another embodiment of the present disclosure from one perspective.

FIG. 57 shows a view of the push rod mechanism in FIG. 56 from another perspective.

FIG. 58 shows a cross-sectional view along P-P of FIG. 56.

FIG. 59 shows an enlarged view of the area X4 in FIG. 58.

FIG. 60 shows a view of the push rod in FIG. 56.

FIG. 61 shows a view of the push rod mechanism of another embodiment of the present disclosure.

FIG. 62 shows a cross-sectional view along R-R of FIG. 61.

FIG. 63 shows a view of the iron core in FIG. 61.

### DETAILED DESCRIPTION

The exemplary embodiments will now be described more comprehensively with reference to the accompanying drawings. However, the exemplary embodiments can be implemented in various forms and should not be understood as is limited to the embodiments described herein. On the contrary, these embodiments are provided to make the present disclosure comprehensive and complete and to fully convey the concepts of the exemplary embodiments to those skilled in the art. Identical reference numerals in the drawings denote identical or similar structures, and therefore, detailed descriptions thereof will be omitted.

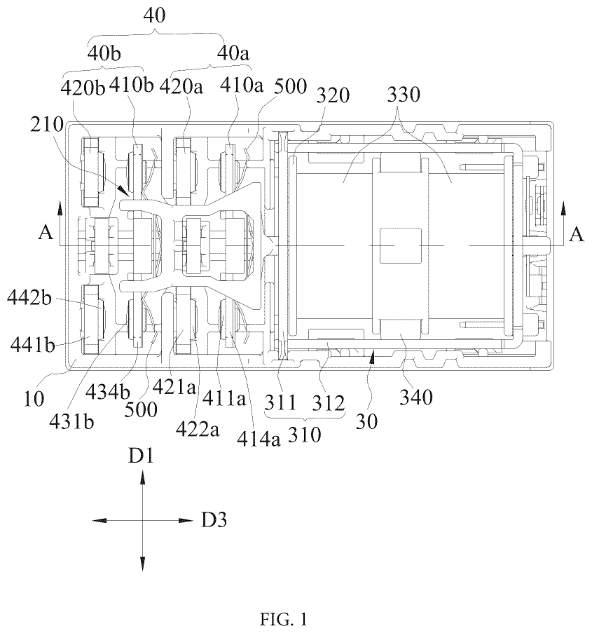

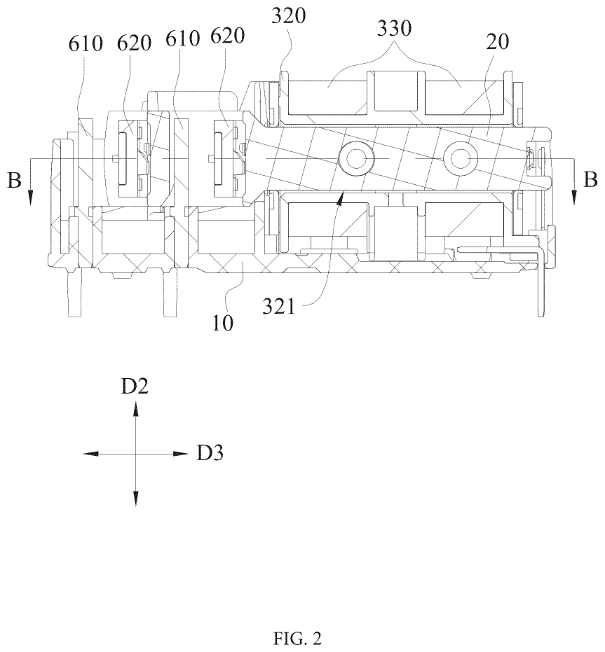

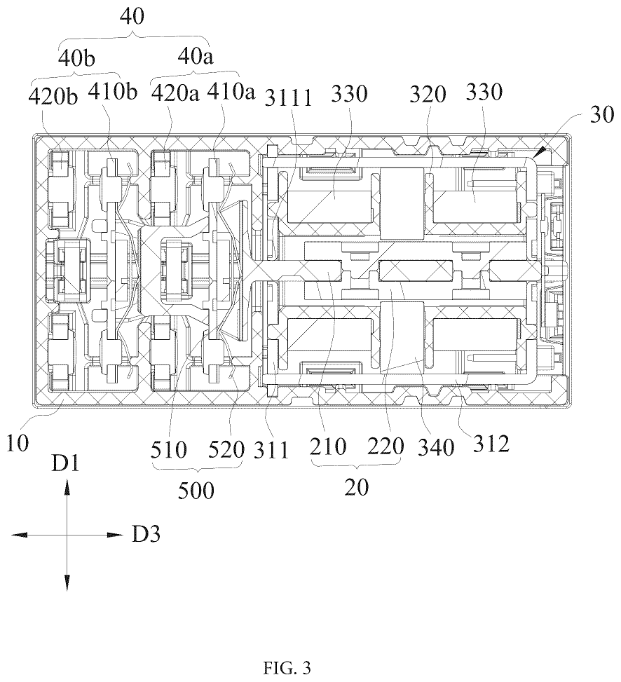

As shown in FIGS. 1 to 3, FIG. 1 shows a top view of the relay of the present disclosure, with the upper cover omitted and the contact assembly in a fully open state. FIG. 2 shows a cross-sectional view along A-A of FIG. 1, and FIG. 3 shows a cross-sectional view along B-B of FIG. 2. The relay of the present disclosure includes a base 10, a push rod mechanism 20, a magnetic circuit mechanism 30, and a contact assembly 40. The push rod mechanism 20, magnetic circuit mechanism 30, and contact assembly 40 are mounted on the base 10. The magnetic circuit mechanism 30 controls the contact or separation of the contacts of the contact assembly 40 through the push rod mechanism 20.

It should be understood that the terms “include” and “have” and any of their variations used in the present disclosure are intended to cover non-exclusive inclusion. For example, a process, method, system, product, or device that includes a series of steps or units is not limited to the listed steps or units but may optionally include steps or units not listed. Alternatively, it may optionally include other steps or components inherent to these processes, methods, products, or devices.

The magnetic circuit mechanism 30 includes a yoke structure 310, a bobbin 320, and a coil 330. The yoke structure 310 forms a chamber, and the bobbin 320 and coil 330 are both located inside the chamber of the yoke structure 310. The coil 330 is wound around the outer periphery of the bobbin 320 to form a magnetic control circuit. The bobbin 320 has a center hole 321 in the contact-separation direction of the contact assembly 40, which is used for the insertion of one end of the push rod mechanism 20.

As an example, the yoke structure 310 includes a yoke plate 311 and a U-shaped yoke 312. The yoke plate 311 is connected to the U-shaped yoke 312 to form a ring. The yoke plate 311 has a through hole 3111, which is used for the insertion of the push rod mechanism 20.

Of course, in other embodiments, the yoke structure 310 may also include a cylindrical yoke and a yoke plate 311, which are connected to form a ring.

The magnetic circuit mechanism 30 also includes two permanent magnets 340, which are mounted on the bobbin 320 and located at both sides of the movement direction D3 of the push rod mechanism 20. The two permanent magnets 340 form a magnetic circuit structure for magnetic latching, which is advantageous for reducing power consumption, extending service life, and improving stability. Of course, in other embodiments, it is also possible not to include permanent magnets 340.

As shown in FIG. 3, the push rod mechanism 20 is movable relative to the base 10 between a first position and a second position along the contact-separation direction of the contact assembly 40. The push rod mechanism 20 includes a push rod 210 and an iron core 220, with the iron core 220 connected to the push rod 210. Under the action of the magnetic control circuit formed by the coil 330, the iron core 220 can move in the contact-separation direction of the contacts, thereby driving the push rod 210 to move to control the contact or separation of the contact assembly 40. The side of the iron core 220 away from the push rod 210 is equipped with the permanent magnet 340.

In this embodiment, the push rod mechanism 20 includes two iron cores 220, which can be respectively mounted on both sides of the push rod 210. Each iron core 220 has a permanent magnet 340 on the side away from the push rod 210.

Referring to FIGS. 1 to 3, the contact assembly 40 includes movable contact pieces (410a, 410b) and static contact pieces (420a, 420b). The static contact pieces (420a, 420b) are fixedly mounted on the base 10, while the movable contact pieces (410a, 410b) are mounted on the push rod mechanism 20 and move with it.

In this embodiment, the contact assembly 40 consists of two sets, namely the first contact assembly 40a and the second contact assembly 40b, which are arranged along the movement direction D3 of the push rod mechanism 20. The first contact assembly 40a is closer to the magnetic circuit mechanism 30, while the second contact assembly 40b is farther from the magnetic circuit mechanism 30.

The first contact assembly 40a includes a first movable contact piece 410a and two first static contact pieces 420a. The second contact assembly 40b includes a second movable contact piece 410b and two second static contact pieces 420b. The ends of the first movable contact piece 410a can come into contact with or separate from the two first static contact pieces 420a, respectively. Similarly, the ends of the second movable contact piece 410b can come into contact with or separate from the two second static contact pieces 420b, respectively.

Of course, in other embodiments, the contact assembly 40 may also consist of one set or another number of sets.

Two ends of the movable contact pieces (410a, 410b) in the length direction D1 serve as movable contacts. The movable contacts may protrude from the other parts of the movable contact pieces (410a, 410b) or may be flush with the other parts. The parts of the static contact pieces (420a, 420b) that contact the movable contacts serve as static contacts. The static contacts may protrude from the other parts of the static contact pieces (420a, 420b) or may be flush with the other parts.

As an example, the first movable contact piece 410a includes a first movable piece body 414a and a first movable contact 411a. The first movable contact 411a is a separate structure from the first movable piece body 414a. The first movable contact 411a and the first movable piece body 414a can be connected by riveting, but not limited to this method. The first static contact piece 420a includes a first static piece body 421a and a first static contact 422a. The first static contact 422a is a separate structure from the first static piece body 421a. The first static contact 422a and the first static piece body 421a can be connected by riveting, but not limited to this method.

The second movable contact piece 410b includes a second movable piece body 434b and a second movable contact 431b. The second movable contact 431b is a separate structure from the second movable piece body 434b. The second movable contact 431b and the second movable piece body 434b can be connected by riveting, but not limited to this method. The second static contact piece 420b includes a second static piece body 441b and a second static contact 442b. The second static contact 442b is a separate structure from the second static piece body 441b. The second static contact 442b and the second static piece body 441b can be connected by riveting, but not limited to this method.

Of course, in another embodiment, the first movable contact 411a and the first movable piece body 414a may be an integral structure; the first static contact 422a and the first static piece body 421a may be an integral structure; the second movable contact 431b and the second movable piece body 434b may be an integral structure; and the second static contact 442b and the second static piece body 441b may be an integral structure.

The relay of the present disclosure also includes an anti-short circuit structure, which may include a first magnetizer 610 and a second magnetizer 620. The first magnetizer 610 is fixedly connected to the base 10, and the second magnetizer 620 is fixedly connected to the first movable contact piece 410a, on the side of the first movable contact piece 410a away from the first magnetizer 610. A magnetic circuit is formed between the first magnetizer 610 and the second magnetizer 620. When a short-circuit current flows through the first movable contact piece 410a, an attractive force along the contact pressure direction is generated between the first magnetizer 610 and the second magnetizer 620. This attractive force can counteract the electromagnetic repulsive force generated between the movable contact of the first movable contact piece 410a and the static contact of the first static contact piece 420a due to the short-circuit current, ensuring that the movable contact of the first movable contact piece 410a and the static contact of the first static contact piece 420a do not separate.

As shown in FIG. 3, the relay also includes elastic components 500, the number of which is the same as that of the contact assemblies 40. In this embodiment, the relay includes two elastic components 500, which are respectively connected to the first movable contact piece 410a of the first contact assembly 40a and the second movable contact piece 410b of the second contact assembly 40b.

The elastic component 500 includes a first elastic portion 510 and a second elastic portion 520, which are an integral structure. The movable contact pieces (410a, 410b) are mounted on the push rod 210 of the push rod mechanism 20 through the first elastic portion 510. The first elastic portion 510 provides contact pressure when the push rod mechanism 20 is in the first position. The second elastic portion 520 provides an elastic force for the push rod mechanism 20 to move towards the first position when the push rod mechanism 20 is in the second position.

Of course, in other implementation methods, the first elastic portion 510 and the second elastic portion 520 may also be separate structures.

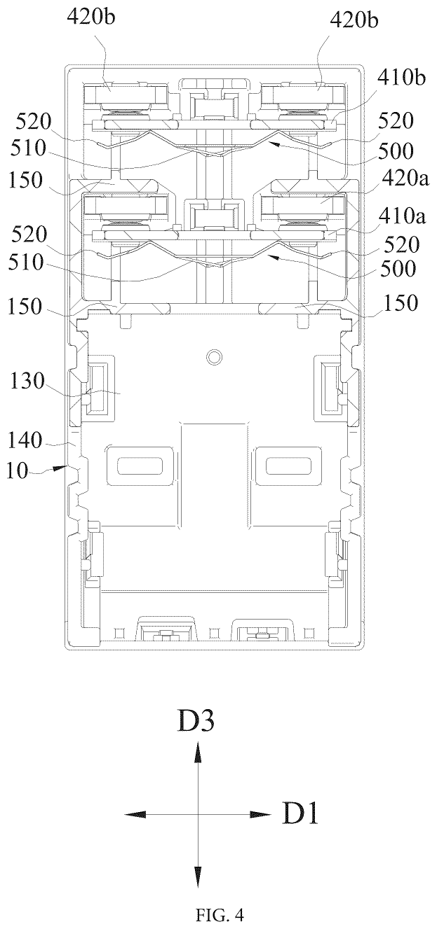

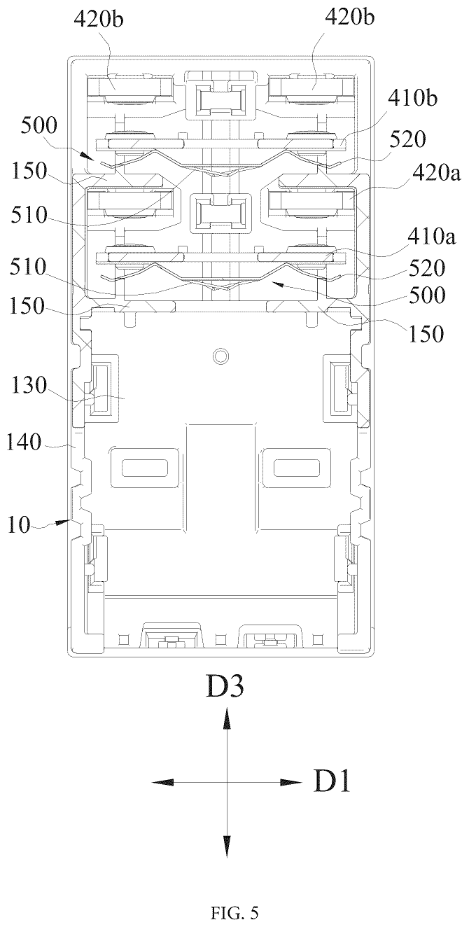

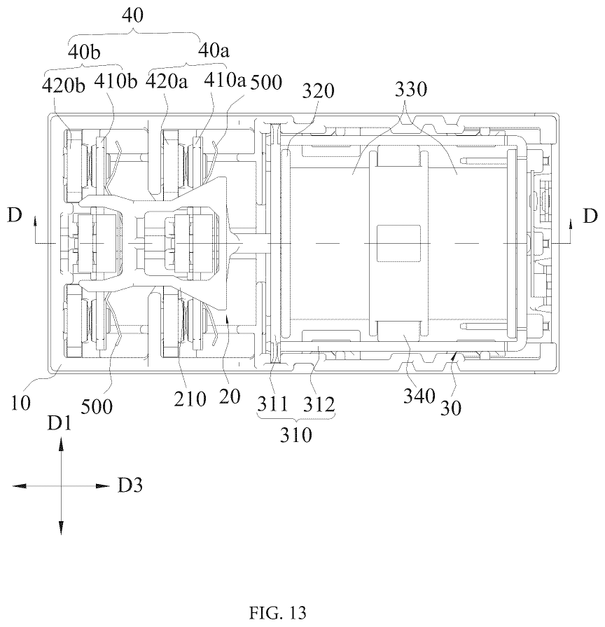

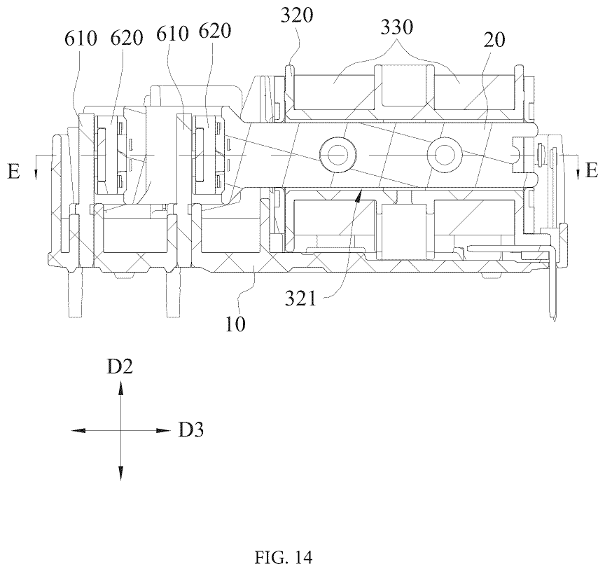

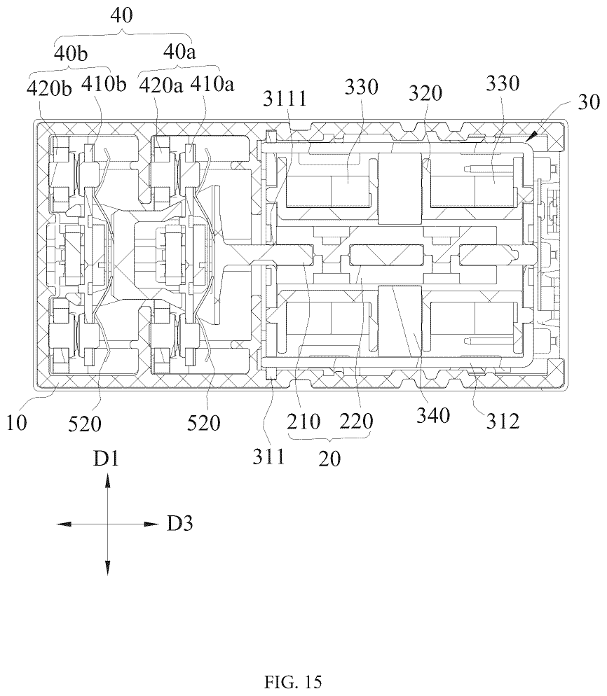

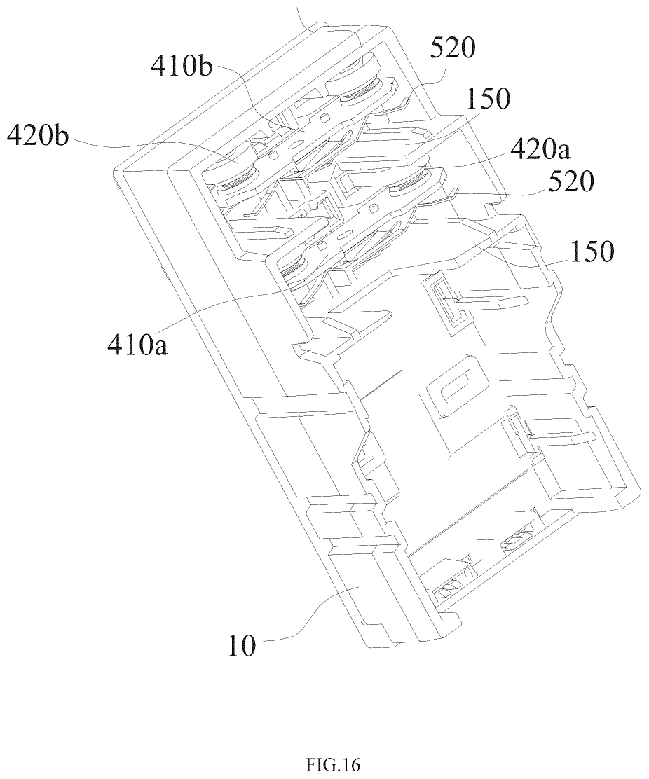

As shown in FIGS. 4 and 5, and in combination with FIGS. 13 to 18, FIG. 4 shows a cross-sectional view of the contact assembly in a fully closed state in FIG. 1, and FIG. 5 shows a cross-sectional view of the contact assembly in a fully open state in FIG. 1, where the push rod mechanism 20 and magnetic circuit mechanism 30 are omitted in FIGS. 4 and 5. FIG. 13 shows a top view of the relay of the present disclosure, with the upper cover omitted and the contact assembly in a fully closed state. FIG. 14 shows a cross-sectional view along D-D of FIG. 13, and FIG. 15 shows a cross-sectional view along E-E of FIG. 14. FIG. 16 shows a perspective view of the contact assembly in a fully closed state in FIG. 1, with the push rod mechanism and magnetic circuit mechanism omitted. FIG. 17 shows a perspective view of the contact assembly in a fully open state in FIG. 1, with the push rod mechanism and magnetic circuit mechanism omitted. FIG. 18 shows a perspective view of the relay during the opening process, with the second elastic portion of the elastic component just contacting the base, and with the push rod mechanism and magnetic circuit mechanism omitted. When the contact assembly 40 is in a fully closed state, the push rod mechanism 20 is in the first position relative to the base 10. When the contact assembly 40 is in a fully open state, the push rod mechanism 20 is in the second position relative to the base 10.

It should be noted that the fully closed state of the contact assembly 40 refers to the state where the movable contact pieces and static contact pieces of the contact assembly 40 contact each other and complete the overtravel (as shown in FIGS. 4, 13, 15, and 16). The fully open state of the contact assembly 40 refers to the state where the movable contact pieces and static contact pieces of the contact assembly 40 separate and the contact gap is maximized (as shown in FIGS. 1, 3, 5, and 17).

When the contact assembly 40 is in a fully closed state, the push rod mechanism 20 is in the first position, and the first elastic portion 510 provides the contact pressure for the overtravel. When the contact assembly 40 is in a fully open state, the push rod mechanism 20 is in the second position, and the second elastic portion 520 provides an elastic force for the push rod mechanism 20 to move towards the first position. Since the second elastic portion 520 provides the elastic force to the push rod mechanism 20 when the contact assembly 40 is in a fully open state, this elastic force gives the push rod mechanism 20 a tendency to move towards the first position. Therefore, when it is necessary to move the push rod mechanism 20 again (i.e., when the contact assembly 40 switches to the closed state) and the coil is energized, the voltage required for coil energization can be reduced because the push rod mechanism 20 is already subjected to the elastic force from the second elastic portion 520. This reduces the operating voltage and brings the operating voltage within the standard range. The standard range for the operating voltage can be between 40% and 60% of the rated voltage, but not limited to this range.

Additionally, by adjusting the magnitude of the elastic force provided by the second elastic portion 520, the operating voltage of the relay can be flexibly adjusted. Specifically, when the elastic force provided by the second elastic portion 520 is increased, the operating voltage of the relay decreases. Conversely, when the elastic force provided by the second elastic portion 520 is decreased, the operating voltage of the relay increases.

Furthermore, when the relay includes a permanent magnet 340 (i.e., the relay has a magnetic latching function), the dropout voltage of the relay can also be flexibly adjusted by changing the magnitude of the elastic force provided by the first elastic portion 510. Specifically, when the elastic force provided by the first elastic portion 510 is increased, the dropout voltage of the relay decreases. Conversely, when the elastic force provided by the first elastic portion 510 is decreased, the dropout voltage of the relay increases.

Therefore, by adjusting the magnitude of the elastic force provided by the second elastic portion 520, the operating voltage can be independently adjusted without affecting the dropout voltage. Similarly, by adjusting the magnitude of the elastic force provided by the first elastic portion 510, the dropout voltage can be independently adjusted without affecting the operating voltage. This allows the operating voltage and the dropout voltage to be in a state of no voltage difference. At this point, by magnetizing or demagnetizing the permanent magnet 340, the magnetic latching force can be increased or decreased, thereby synchronously adjusting the operating voltage and the dropout voltage without the need to adjust the tolerances of other components of the relay. This reduces the precision requirements for other components.

It should be understood that the magnitude of the elastic force provided by the second elastic portion 520 can be adjusted by changing its elastic modulus. For example, the elastic modulus of the second elastic portion 520 can be changed by altering its deflection in the uncompressed state or by changing its width, but not limited to these methods.

As shown in FIG. 4, when the push rod mechanism 20 is in the first position (i.e., the contact assembly 40 is in a fully closed state), the second elastic portion 520 does not provide an elastic force to the push rod mechanism 20.

As shown in FIG. 5, when the push rod mechanism 20 is in the second position (i.e., the contact assembly 40 is in a fully open state), one end of the second elastic portion 520 abuts against the movable contact pieces (410a, 410b), and the other end of the second elastic portion 520 abuts against the base 10.

Of course, in other embodiments, when the push rod mechanism 20 is in the second position, one end of the second elastic portion 520 also abuts against the push rod 210 of the push rod mechanism 20, and the other end of the second elastic portion 520 abuts against the base 10.

Referring to FIG. 5, the base 10 includes a bottom wall 130, a side wall 140, and a stop portion 150. The side wall 140 is connected to the bottom wall 130 and can surround the edge of the bottom wall 130. The side wall 140 and the bottom wall 130 together form a space for accommodating the push rod mechanism 20, the magnetic circuit mechanism 30, the contact assembly 40, and the elastic component 500, etc. The stop portion 150 is connected to the inner surface of the side wall 140 and/or the inner surface of the bottom wall 130 and is configured to abut against the second elastic portion 520.

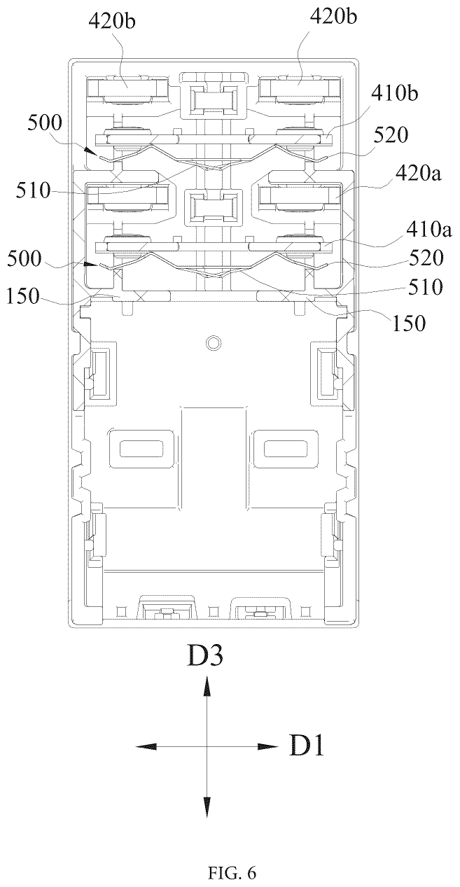

As shown in FIG. 6, FIG. 6 shows a cross-sectional view of the relay during the opening process, with the second elastic portion 520 of the elastic component 500 just contacting the base 10. The push rod mechanism 20 and magnetic circuit mechanism 30 are omitted in FIG. 6. When the contact assembly 40 of the relay switches from a fully open state to a fully closed state (i.e., from FIG. 5 to FIG. 4), it passes through an intermediate state in which the second elastic portion 520 of the elastic component 500 just contacts the base 10.

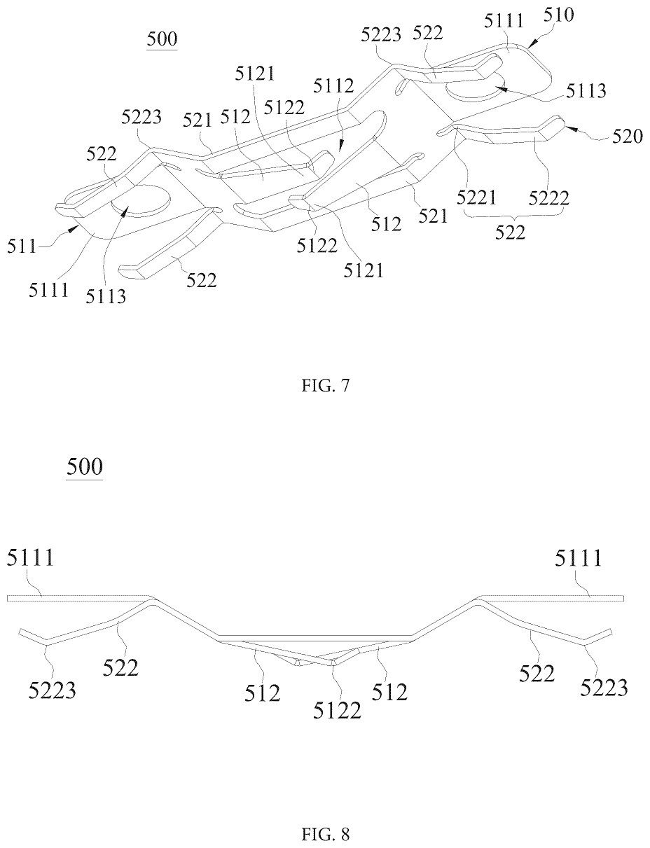

As shown in FIGS. 7 and 8, FIG. 7 shows a perspective view of the elastic component 500, and FIG. 8 shows a side view of the elastic component 500. The first elastic portion 510 of the elastic component 500 includes a main piece 511 and a first elastic arm 512. The main piece 511 extends along the length direction D1 of the movable contact pieces (410a, 410b) and has connection portions 5111 at both ends along the length direction D1. The connection portions 5111 are used for fixed connection with the movable contact pieces (410a, 410b), and an opening 5112 is provided between the two connection portions 5111. One end of the first elastic arm 512 is connected to the edge of the opening 5112, and the other end is configured to abut against the push rod mechanism 20. The other end of the first elastic arm 512 has a first bend 5121, and a protrusion 5122 of the first bend 5121 is configured to abut against the push rod mechanism 20.

In this embodiment, the first elastic portion 510 includes two first elastic arms 512, which are symmetrically arranged around the center of the opening 5112.

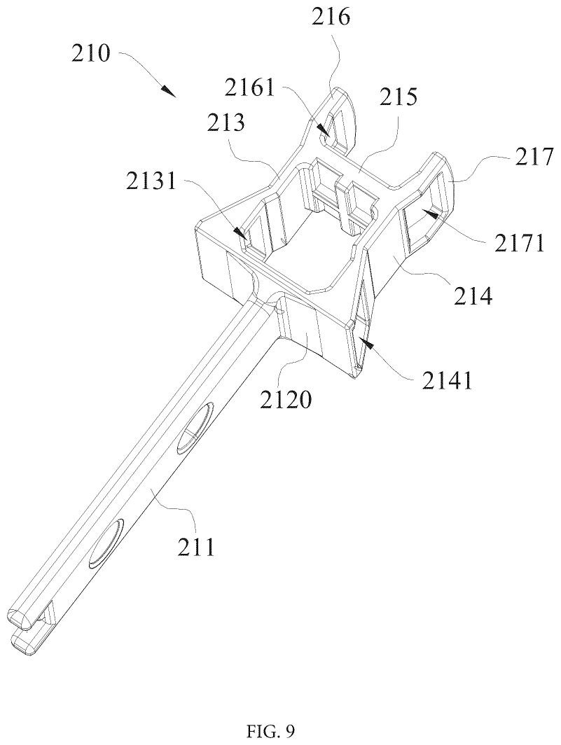

The connection portion 5111 has a connection hole 5113, and the movable contacts at both ends of the movable contact pieces (410a, 410b) pass through the connection hole 5113 (as shown in FIG. 9). The plane where the opening 5112 is located is not coplanar with the plane where the connection portion 5111 is located.

Referring to FIGS. 7 and 8, the second elastic portion 520 of the elastic component 500 includes two elastic pieces 521, which are respectively located at both sides of the first elastic portion 510 along the width direction D2 of the movable contact pieces (410a, 410b). Each elastic piece 521 has two second elastic arms 522 at both ends along the length direction D1 of the movable contact pieces (410a, 410b), which are used to press between the movable contact pieces (410a, 410b) and the base 10.

By adjusting the initial deflection of the second elastic arm 522 in the uncompressed state, the magnitude of the elastic force provided by the second elastic arm 522 can be adjusted, thereby regulating the operating voltage of the relay.

The second elastic arm 522 includes a second bend 5221 and a spring strip 5222. A protrusion 5223 of the second bend 5221 is configured to abut against the movable contact pieces (410a, 410b). One end of the spring strip 5222 is connected to the second bend 5221, and the other end is configured to abut against the base 10.

When the contact assembly 40 is in a fully open state (i.e., the push rod mechanism 20 is in the second position), the spring strip 5222 deforms to provide an elastic force to the push rod mechanism 20, which gives the push rod mechanism 20 a tendency to move towards the first position.

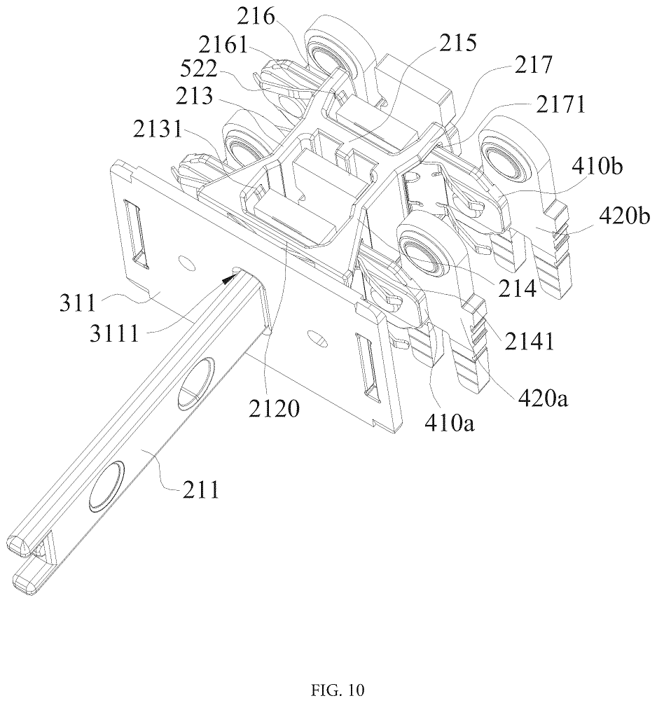

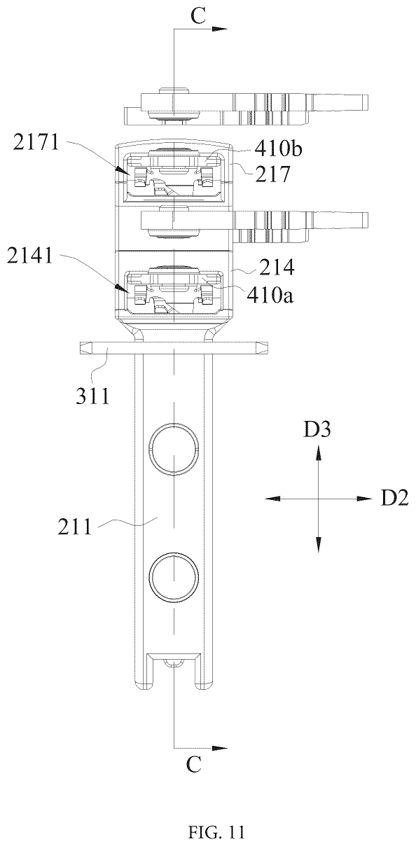

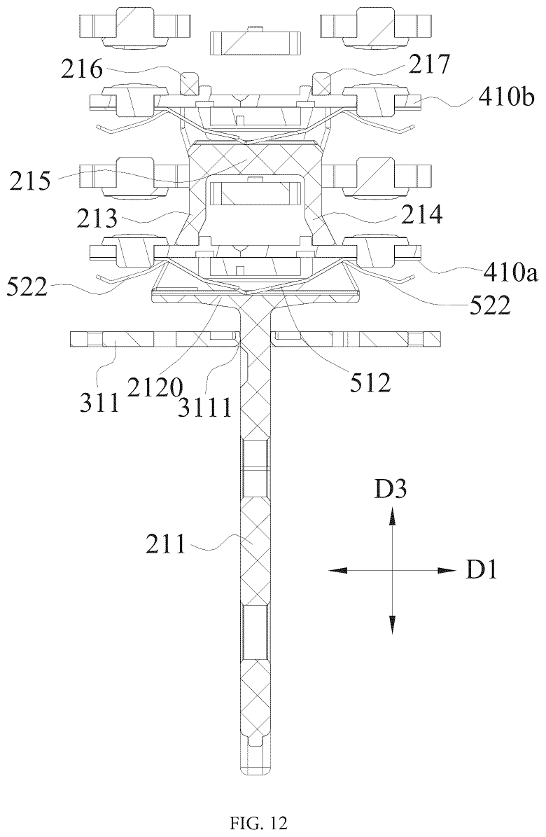

As shown in FIGS. 9 to 12, FIG. 9 shows a perspective view of the push rod 210, FIG. 10 shows an assembly view of the push rod 210, yoke plate 311, elastic component 500, and contact assembly 40, FIG. 11 shows a side view of FIG. 10, and FIG. 12 shows a cross-sectional view along C-C of FIG. 11. The push rod 210 includes a rod portion 211, a bottom portion 2120, a first side portion 213, and a second side portion 214. The first movable contact piece 410a is connected to the bottom portion 2120 through the first elastic portion 510. One of the elastic components 500 is located between the first movable contact piece 410a and the bottom portion 2120. The rod portion 211 is movably inserted through the through hole 3111 of the yoke plate 311, and the iron core 220 is connected to the rod portion 211. The bottom portion 2120 is connected to one end of the rod portion 211 in the axial direction. The first side portion 213 and the second side portion 214 are both connected to the bottom portion 2120 and are arranged oppositely along the length direction D1 of the first movable contact piece 410a. The first side portion 213 has a first through hole 2131, and the second side portion 214 has a second through hole 2141. The first movable contact piece 410a and the elastic component 500 both pass through the first through hole 2131 and second through hole 2141. Along the axial direction of the rod portion 211 (i.e., the movement direction D3 of the push rod mechanism 20), the first movable contact piece 410a is movable between a third position and a fourth position relative to the first through hole 2131 and second through hole 2141. In the third position, the first movable contact piece 410a abuts against the walls of the first through hole 2131 and second through hole 2141. The first elastic portion 510 abuts against between the bottom portion 2120 and the first movable contact piece 410a, providing an elastic force for the first movable contact piece 410a to move towards the third position. The connection portion 5111 of the first elastic portion 510 is connected to the first movable contact piece 410a, and the protrusion 5122 of the first bend 5121 abuts against the bottom portion 2120.

When the push rod mechanism 20 is in the first position, the first movable contact piece 410a is in the fourth position; when the push rod mechanism 20 is in the second position, the first movable contact piece 410a is in the third position.

During the closing process of the first contact assembly 40a of the relay, the push rod 210 drives the first movable contact piece 410a to move towards the first static contact piece 420a. Before the first movable contact piece 410a contacts the first static contact piece 420a, the first movable contact piece 410a abuts against the walls of the first through hole 2131 and second through hole 2141 and is in the third position under the action of the first elastic portion 510. After the first movable contact piece 410a contacts the first static contact piece 420a, since the first static contact piece 420a is fixedly installed on the base 10, the first movable contact piece 410a is stopped by the first static contact piece 420a and cannot continue to move. At this time, the push rod 210 continues to move, and the first elastic arm 512 of the first elastic portion 510 deforms and is gradually compressed until the overtravel is completed. At this time, the first movable contact piece 410a is in the fourth position relative to the first through hole 2131 and second through hole 2141, and the push rod mechanism 20 is in the first position. During the movement of the push rod mechanism 20 from the second position to the first position, the second elastic arm 522 of the second elastic portion 520 transitions from a compressed state to a state where the second elastic arm 522 contacts the stop portion 150 of the base 10, and then to a state where the second elastic arm 522 separates from the stop portion 150 of the base 10.

During the separation process of the first contact assembly 40a of the relay, the movement of the push rod 210 away from the first static contact piece 420a can be divided into two stages: In the first stage, the push rod 210 moves while the first movable contact piece 410a does not move with the push rod 210. In the first stage, the first movable contact piece 410a moves from the fourth position to the third position relative to the first through hole 2131 and second through hole 2141. At the beginning of the second stage, the first movable contact piece 410a has already moved to the third position relative to the first through hole 2131 and second through hole 2141, contacting the walls of the first through hole 2131 and second through hole 2141. Thereafter, the movement of the push rod 210 drives the first movable contact piece 410a to move, causing the first movable contact piece 410a to separate from the first static contact piece 420a. In the second stage, when the push rod 210 drives the first movable contact piece 410a to move, since the first movable contact piece 410a abuts against the walls of the first through hole 2131 and second through hole 2141, it is equivalent to the push rod 210 acting on the first movable contact piece 410a through the first side portion 213 and second side portion 214, causing the first movable contact piece 410a to separate from the first static contact piece 420a.

During the process of the push rod mechanism 20 driving the first movable contact piece 410a to move towards the second position, the second elastic arm 522 of the second elastic portion 520 first contacts the stop portion 150 of the base 10. As the push rod mechanism 20 moves, the second elastic arm 522 deforms and is compressed, providing an elastic force to the push rod mechanism 20 until the push rod mechanism 20 reaches the second position.

It should be understood that, on the one hand, the first elastic portion 510 and the second elastic portion 520 of the elastic component 500 are an integral structure, and both the elastic component 500 and the first movable contact piece 410a are inserted through the first through hole 2131 and second through hole 2141. The first elastic portion 510 provides the contact pressure for the overtravel, and the second elastic portion 520 provides an elastic force for the push rod mechanism 20 to move towards the closed direction, reducing the operating voltage of the relay. Therefore, in this embodiment, the relay meets the requirement of flexible adjustment of the operating voltage. The structure after assembly of the elastic component 500, the first movable contact piece 410a, and the push rod 210 is also more compact, which is conducive to miniaturization of the relay.

On the other hand, the position where the wall of the first through hole 2131 abuts against the first movable contact piece 410a is equivalent to a point of force application, and the position where the wall of the second through hole 2141 abuts against the first movable contact piece 410a is equivalent to another point of force application. By setting two points of force application along the length direction D1 of the first movable contact piece 410a, the area subjected to the pulling force of the push rod 210 on the first movable contact piece 410a is larger, making the movement of the first movable contact piece 410a driven by the push rod 210 more stable.

Referring to FIGS. 9 to 12, the push rod 210 also includes a spacing portion 215, a third side portion 216, and a fourth side portion 217. The third side portion 216 is connected to one end of the first side portion 213 away from the bottom portion 2120, and the fourth side portion 217 is connected to one end of the second side portion 214 away from the bottom portion 2120. The spacing portion 215 is located between the third side portion 216 and the fourth side portion 217. The third side portion 216 has a third through hole 2161, and the fourth side portion 217 has a fourth through hole 2171. The second movable contact piece 410b and another elastic component 500 are inserted through the third through hole 2161 and fourth through hole 2171. The third through hole 2161 is located at one side of the spacing portion 215 along the axial direction of the rod portion 211, and the first through hole 2131 is located at the other side of the spacing portion 215 along the axial direction of the rod portion 211. The fourth through hole 2171 is located at one side of the spacing portion 215 along the axial direction of the rod portion 211, and the second through hole 2141 is located at the other side of the spacing portion 215 along the axial direction of the rod portion 211. Along the axial direction of the rod portion 211, the second movable contact piece 410b is movable between a fifth position and a sixth position relative to the third through hole 2161 and fourth through hole 2171. In the fifth position, the second movable contact piece 410b abuts against the walls of the third through hole 2161 and fourth through hole 2171. Another elastic component 500 is located between the second movable contact piece 410b and the spacing portion 215, providing an elastic force for the second movable contact piece 410b to move towards the fifth position.

The process of the push rod 210 driving the second movable contact piece 410b to come into contact with or separate from the first static contact piece 420a is the same as that of the first contact assembly 40a, and will not be repeated here.

Therefore, the position where the wall of the third through hole 2161 abuts against the second movable contact piece 410b is equivalent to a point of force application, and the position where the wall of the fourth through hole 2171 abuts against the second movable contact piece 410b is equivalent to another point of force application. By setting two points of force application along the length direction D1 of the second movable contact piece 410b, the area subjected to the pulling force of the push rod 210 on the second movable contact piece 410b is larger, making the movement of the second movable contact piece 410b driven by the push rod 210 more stable.

The relay of the embodiments of the present disclosure can adjust the operating voltage by changing the elasticity of the second elastic portion.

Furthermore, when the relay has a permanent magnet (i.e., the relay has a magnetic latching function), the dropout voltage can be independently adjusted by changing the elasticity of the first elastic portion, without affecting the operating voltage. The operating voltage can be independently adjusted by changing the elasticity of the second elastic portion, without affecting the dropout voltage. This allows the operating voltage and the dropout voltage to be in a state of no voltage difference. At this time, the magnetic latching force can be increased or decreased by magnetizing or demagnetizing the permanent magnet, thereby synchronously adjusting the operating voltage and the dropout voltage without the need to adjust the tolerances of other components of the relay, reducing the precision requirements for other components.

It should be understood that the various embodiments/implementations provided in this disclosure can be combined with each other without contradiction, and will not be listed one by one here.

In the existing magnetic latching relays, the magnetic circuit structure is generally an H-type magnetic circuit, and the contact system is a hinge type. If it is necessary to increase the contact gap, that is, to pull the contact head a greater distance, then the length of the movable contact piece must be long enough, and sufficient space is required. At this time, the volume of the relay will increase, and the material cost will also increase due to the increased length of the movable contact piece.

This disclosure also provides a relay to solve the problem of increased relay volume and increased material costs in the relevant technology.

The relay of this disclosure includes a base, a push rod mechanism, and a contact assembly. The push rod mechanism includes a push rod and an iron core. The push rod includes a mounting portion and a rod portion. The mounting portion is connected to one end of the rod portion in an axial direction, and the iron core is fixedly connected to the rod portion. The push rod and the iron core can move linearly relative to the base. The contact assembly includes a static contact piece and a movable contact piece. The static contact piece is fixedly connected to the base and includes a contact terminal and a lead-out terminal. The movable contact piece is mounted on the mounting portion so that the push rod mechanism can drive the movable contact piece to move to come into contact with or separate from the contact terminal. The lead-out terminal extends out from the bottom surface of the base and is used for electrical connection with an external circuit. A width of the lead-out terminal is smaller than a width of the contact terminal.

According to some embodiments of this disclosure, the static contact piece is inserted into the base along an insertion direction, insertion direction is perpendicular to both the movement direction of the push rod mechanism and the length direction of the movable contact piece.

According to some embodiments of this disclosure, the extension direction of the lead-out terminal is parallel to the insertion direction.

According to some embodiments of this disclosure, the static contact piece includes two lead-out terminals, both of the two lead-out terminals extend out from the bottom surface of the base, and the extension direction of each lead-out terminal is perpendicular to the movement direction of the push rod mechanism.

According to some embodiments of this disclosure, the two lead-out terminals are arranged side by side along the length direction of the movable contact piece.

According to some embodiments of this disclosure, the contact assembly includes multiple sets arranged sequentially along the movement direction of the push rod mechanism.

According to some embodiments of this disclosure, the base has a mounting hole that penetrates an inner surface and a bottom surface of the base. The wall of the mounting hole has a positioning wall structure and a gap wall structure;
the static contact piece is inserted through the mounting hole, and part of outer wall surface of the static contact piece abuts against the positioning wall structure, while another part of outer wall surface of the static contact piece has a gap with the gap wall structure, which is filled with positioning glue.

According to some embodiments of this disclosure, the static contact piece is in interference fit with the positioning wall structure.

According to some embodiments of this disclosure, the positioning wall structure includes a first positioning wall and a second positioning wall arranged oppositely along a positioning direction.

According to some embodiments of this disclosure, the static contact piece includes two lead-out terminals, both of the two lead-out terminals extend out from the bottom surface of the base, and the extension direction of each lead-out terminal is perpendicular to the movement direction of the push rod mechanism. The base has two mounting holes corresponding the two lead-out terminals, and the two lead-out terminals are inserted through the two mounting holes, respectively. Each lead-out terminal abuts against the positioning wall structure of corresponding mounting hole and has a gap with the gap wall structure.

According to some embodiments of this disclosure, the external circuit includes a circuit board, and the lead-out terminal is soldered to the circuit board.

The above-mentioned embodiments of the disclosure have at least the following advantages or beneficial effects:

In the relay of this disclosure, the push rod mechanism moves linearly relative to the base, forming a direct-acting magnetic circuit structure. The distance that the movable contact piece and the static contact piece of the contact assembly are pulled apart is the contact gap. Under the condition of maintaining the same volume of the relay, the contact gap of this embodiment is much larger than that of the relevant technology. In addition, the width of the contact terminal is designed to be wider, allowing heat to be quickly distributed on the contact terminal, avoiding the impact of excessive heat on the interior of the relay.

In addition, since the direction in which the lead-out terminal of the static contact piece extends out from the bottom surface of the base is perpendicular to the movement direction of the push rod mechanism, combined with the direct-acting magnetic circuit, it can significantly reduce the material cost of the contact assembly. Moreover, multiple sets of contact assemblies can be arranged along the movement direction of the push rod mechanism.

The following is a detailed description in combination with the drawings.

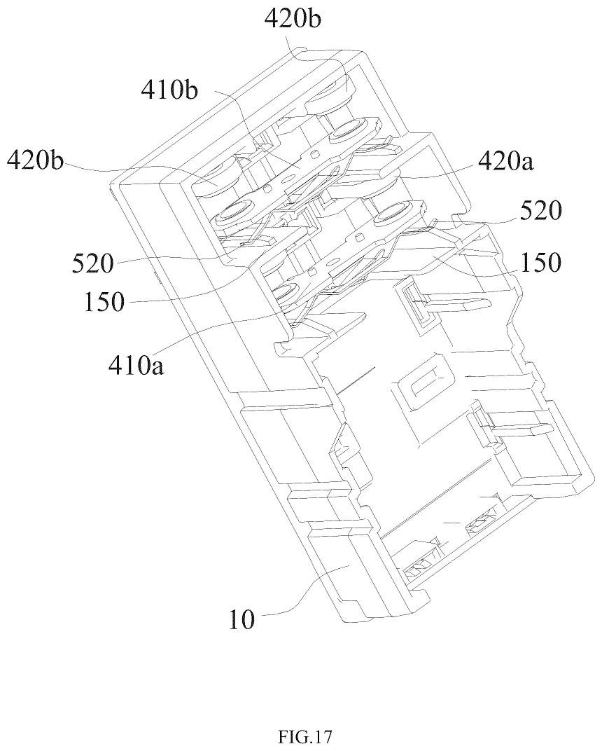

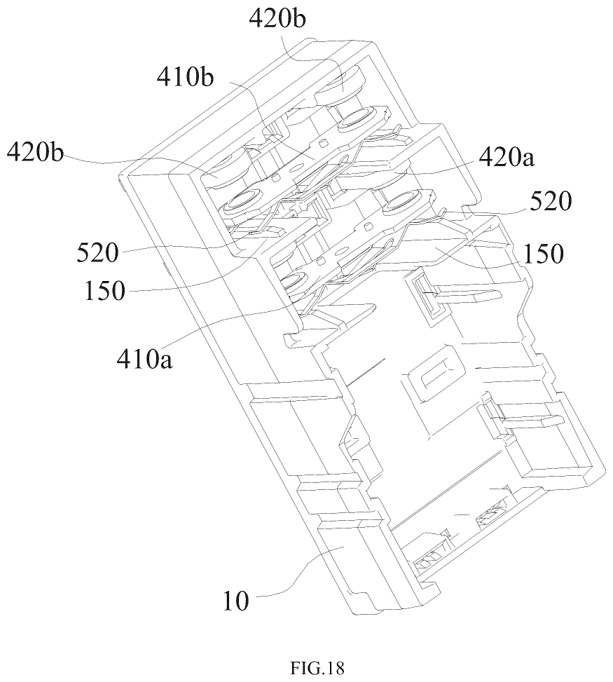

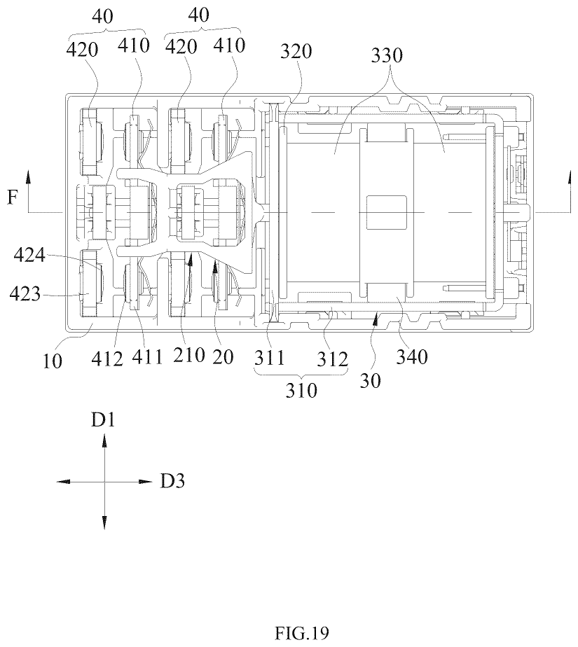

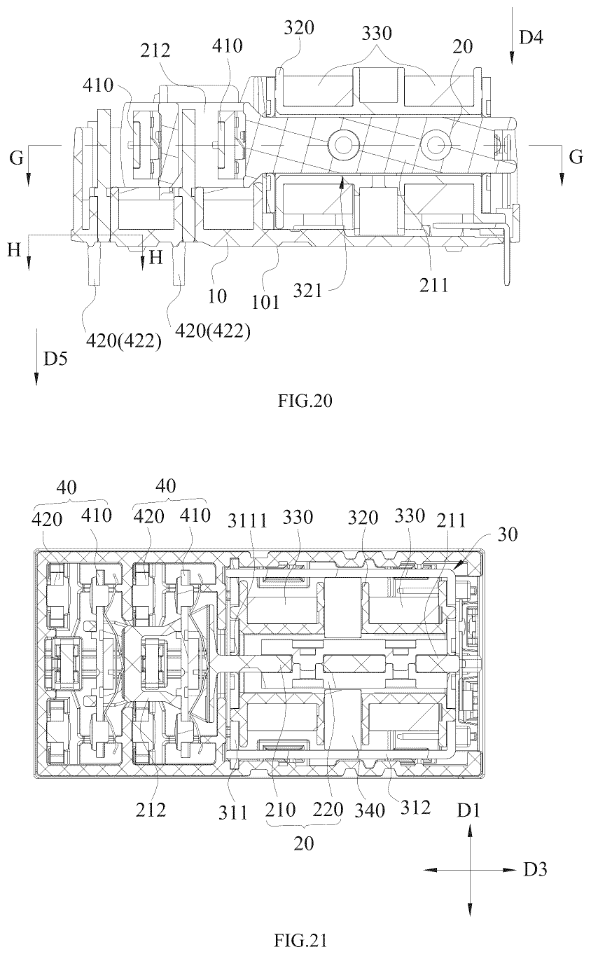

As shown in FIGS. 19 to 21, FIG. 19 shows a top view of the relay of this disclosure, with the upper cover omitted. FIG. 20 shows a cross-sectional view along F-F of FIG. 19, and FIG. 21 shows a cross-sectional view along G-G of FIG. 20. The relay of this disclosure includes a base 10, a push rod mechanism 20, a magnetic circuit mechanism 30, and a contact assembly 40. The push rod mechanism 20, magnetic circuit mechanism 30, and contact assembly 40 are mounted on the base 10, and the magnetic circuit mechanism 30 controls the contact or separation of the contact assembly 40 through the push rod mechanism 20.

It should be understood that the terms “include” and “have” and any of their variations used in this disclosure are intended to cover non-exclusive inclusion. For example, a process, method, system, product, or device that includes a series of steps or units is not limited to the listed steps or units but may optionally include steps or units not listed. Alternatively, it may optionally include other steps or components inherent to these processes, methods, products, or devices.

The magnetic circuit mechanism 30 includes a yoke structure 310, a bobbin 320, and a coil 330. The yoke structure 310 forms a chamber, and the bobbin 320 and coil 330 are both located inside the chamber of the yoke structure 310. The coil 330 is wound around the outer periphery of the bobbin 320 to form a magnetic control circuit. The bobbin 320 has a center hole 321 in the contact-separation direction of the contact assembly 40, which is used for the insertion of one end of the push rod mechanism 20.

As an example, the yoke structure 310 includes a yoke plate 311 and a U-shaped yoke 312, which are connected to form a ring. The yoke plate 311 has a through hole 3111, which is used for the insertion of the push rod mechanism 20.

Of course, in other embodiments, the yoke structure 310 may also include a cylindrical yoke and a yoke plate 311, which are connected to form a ring.

The magnetic circuit mechanism 30 also includes two permanent magnets 340, which are mounted on the bobbin 320 and located at both sides of the movement direction D3 of the push rod mechanism 20. The two permanent magnets 340 form a magnetic latching circuit structure, which is advantageous for reducing power consumption, extending service life, and improving stability.

Of course, in other embodiments, it is also possible not to include permanent magnets 340.

Referring to FIGS. 19 to 20, the contact assembly 40 includes movable contact pieces 410 and static contact pieces 420. The static contact pieces 420 are fixedly installed on the base 10, and the movable contact pieces 410 are mounted on the push rod mechanism 20 and move with it.

In this embodiment, the contact assembly 40 consists of two sets, which are arranged along the movement direction D3 of the push rod mechanism 20.

Of course, in other embodiments, the contact assembly 40 may also consist of one set or other number of sets.

The length direction ends of the movable contact piece 410 serve as the movable contacts. The movable contacts may protrude from the other parts of the movable contact piece 410 or may be flush with the other parts. The parts of the static contact piece 420 that contact the movable contact piece 410 serve as the static contacts. The static contacts may protrude from the other parts of the static contact piece 420 or may be flush with the other parts.

As an example, the movable contact piece 410 includes a movable piece body 411 and a movable contact 412. The movable contact 412 and the movable piece body 411 are separate structures. The movable contact 412 and the movable piece body 411 can be connected by riveting, but not limited to this method. The static contact piece 420 includes a static piece body 423 and a static contact 424. The static contact 424 and the static piece body 423 are separate structures. The static contact 424 and the static piece body 423 can be connected by riveting, but not limited to this method.

Of course, in another embodiment, the movable contact 412 and the movable piece body 411 can also be an integral structure, and the static contact 424 and the static piece body 423 can be an integral structure.

The number of static contact pieces 420 in the contact assembly 40 can be two. The two static contact pieces 420 are arranged along the length direction of the movable contact piece 410. The length direction ends of the movable contact piece 410 are used to come into contact with or separate from the two static contact pieces 420, respectively, forming a bridge-type contact assembly 40.

As shown in FIG. 21, the push rod mechanism 20 is movable linearly relative to the base 10. The push rod mechanism 20 includes a push rod 210 and an iron core 220, with the iron core 220 connected to the push rod 210. Under the action of the magnetic control circuit formed by the coil 330, the iron core 220 can move in the contact-separation direction of the contacts, thereby driving the push rod 210 to move and controlling the contact or separation of the contacts of the contact assembly 40. The movable contact piece 410 of the contact assembly 40 is mounted on the push rod 210.

The push rod 210 includes a mounting portion 212 and a rod portion 211, with the mounting portion 212 connected to one end of the rod portion 211 in the axial direction. The movable contact piece 410 is mounted on the mounting portion 212, and the iron core 220 is fixedly connected to the rod portion 211. The contact-separation direction between the static contact piece 420 and the movable contact piece 410 is parallel to the movement direction D3 of the push rod mechanism 20. In this embodiment, the relay is a direct-acting magnetic circuit.

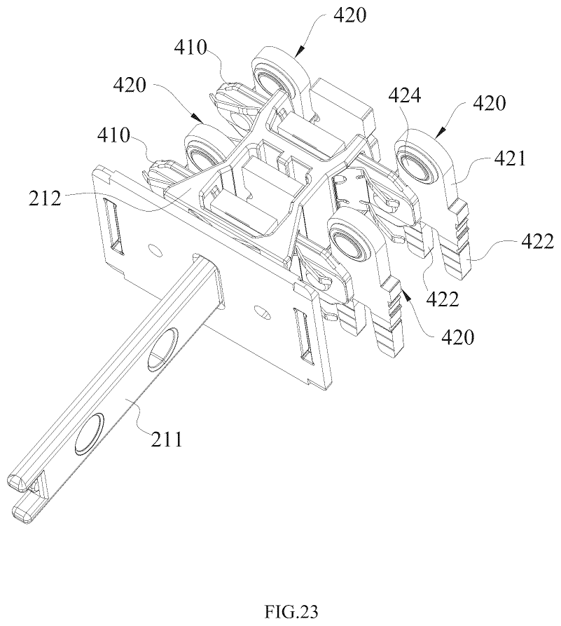

As shown in FIGS. 20, 22, and 23, FIG. 22 shows an exploded view of the static contact piece 420 and the static contact 424. FIG. 23 shows an assembly view of the contact assembly 40 and the push rod 210. The static contact piece 420 includes a contact terminal 421 and a lead-out terminal 422. The contact terminal 421 is equipped with a static contact 424. The static contact 424 on the contact terminal 421 is used to come into contact with or separate from the movable contact of the movable contact piece 410. The lead-out terminal 422 extends out from the bottom surface 101 of the base 10 and is used for electrical connection with an external circuit. The extension direction D5 of the lead-out terminal 422 is perpendicular to the movement direction D3 of the push rod mechanism.

In this embodiment of the relay, the push rod 210 and the iron core 220 of the push rod mechanism 20 are both movable linearly relative to the base 10, forming a direct-acting magnetic circuit structure. The distance that the movable contact piece 410 and the static contact piece 420 are pulled apart is the contact gap. Under the condition of maintaining the same volume of the relay, the contact gap of this embodiment is much larger than that of the relevant technology. Additionally, since the extension direction D5 of the lead-out terminal 422 of the static contact piece 420 is perpendicular to the movement direction D3 of the push rod mechanism 20, in combination with the direct-acting magnetic circuit, it can significantly reduce the material cost of the contact assembly and allow multiple sets of contact assemblies 40 to be arranged along the movement direction D3 of the push rod mechanism 20.

It should be noted that the bottom surface 101 of the base 10 refers to: the surface of the base 10 facing the circuit board when the relay is assembled onto the circuit board.

The width W1 of the lead-out terminal 422 is smaller than the width W2 of the contact terminal 421. Designing the width of the lead-out terminal 422 to be narrower helps reduce the thermal conductivity of the static contact piece 420, improves the soldering performance of high-capacity lead-out terminals, and facilitates the electrical connection of the lead-out terminal 422 with the external circuit. At the same time, designing the width W2 of the contact terminal 421 to be wider allows heat to be quickly distributed on the contact terminal 421, avoiding the impact of excessive heat on the interior of the relay.

It should be noted that the “width” of the lead-out terminal 422 and the contact terminal 421 can be understood as: the dimensions of the lead-out terminal 422 and the contact terminal 421 along the length direction D1 of the movable contact piece 410. Moreover, along the length direction D1 of the movable contact piece 410, the maximum width W1 of the lead-out terminal 422 should be smaller than the width W2 of the contact terminal 421.

It can be understood that the external circuit may include a circuit board (not shown in drawings). The electrical connection method between the lead-out terminal 422 of the static contact piece 420 and the circuit board can be soldering. Of course, the lead-out terminal 422 of the static contact piece 420 can also be connected to the external circuit by plug-in connection.

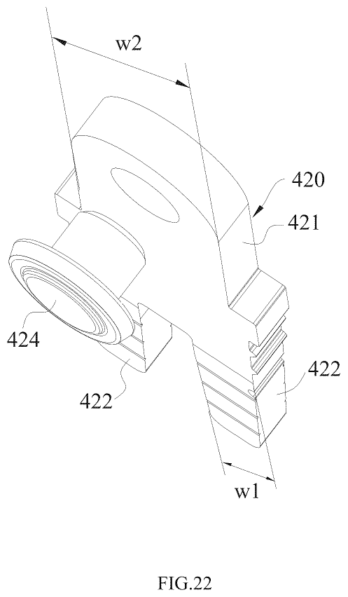

Referring to FIGS. 22 and 23, the static contact piece 420 includes two lead-out terminals 422, both of which extend out from the bottom surface 101 of the base 10. The extension direction D5 of each lead-out terminal 422 is perpendicular to the movement direction D3 of the push rod mechanism 20.

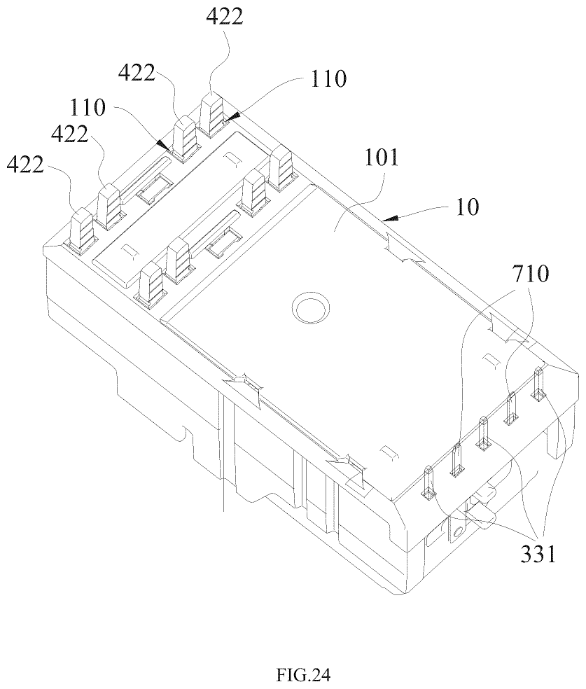

In this embodiment, both lead-out terminals 422 are connected to the contact terminal 421 of the static contact piece 420, forming a forked structure, thereby reducing the thermal conductivity of the static contact piece 420 and improving the soldering performance of high-capacity lead-out terminals. As shown in FIG. 24, FIG. 24 shows another schematic diagram of the relay of this embodiment, with the bottom surface 101 of the base 10 facing upwards. The two lead-out terminals 422 of the static contact piece 420 are arranged side by side along the length direction D1 of the movable contact piece 410.

Combining FIGS. 20, 23, and 24, the contact assembly 40 includes a pair of static contact pieces 420 and a movable contact piece 410. The pair of static contact pieces 420 are arranged along the length direction D1 of the movable contact piece 410. Two ends of the movable contact piece 410 in the length direction D1 are used to come into contact with or separate from the contact terminals 421 of the pair of static contact pieces 420.

In this embodiment, two ends of the movable contact piece 410 in the length direction D1 come into contact with or separate from the contact terminals 421 of the pair of static contact pieces 420, forming a bridge-type contact system.

As shown in FIG. 24, as an example, the relay of this embodiment includes two sets of contact assemblies 40, and each set of contact assembly 40 includes two static contact pieces 420 and one movable contact piece 410. Therefore, along the movement direction D3 of the push rod mechanism 20, the bottom surface 101 of the base 10 has two rows of lead-out terminals 422, and along the length direction D1 of the movable contact piece 410, each row of lead-out terminals 422 includes four lead-out terminals 422.

Additionally, the coil lead-out terminal 331 also extends out from the bottom surface 101 of the base 10. The extension direction of the coil lead-out terminal 331 is the same as that of the lead-out terminal 422 of the static contact piece 420, allowing for welding in the same direction.

Furthermore, an auxiliary contact lead-out terminal 710 also extends out from the bottom surface 101 of the base 10. The extension direction of the auxiliary contact lead-out terminal 710 is also the same as that of the lead-out terminal 422 of the static contact piece 420. Therefore, the lead-out terminal 422 of the static contact piece 420, the coil lead-out terminal 331, and the auxiliary contact lead-out terminal 710 can all be welded in the same direction at the same time, improving assembly efficiency.

Referring back to FIG. 20, the static contact piece 420 is inserted into the base 10 along an insertion direction D4. The insertion direction D4 is perpendicular to the movement direction D3 of the push rod mechanism 20 and is also perpendicular to the length direction D1 of the movable contact piece 410.

The extension direction D5 of the lead-out terminal 422 of the static contact piece 420 is parallel to the insertion direction D4.

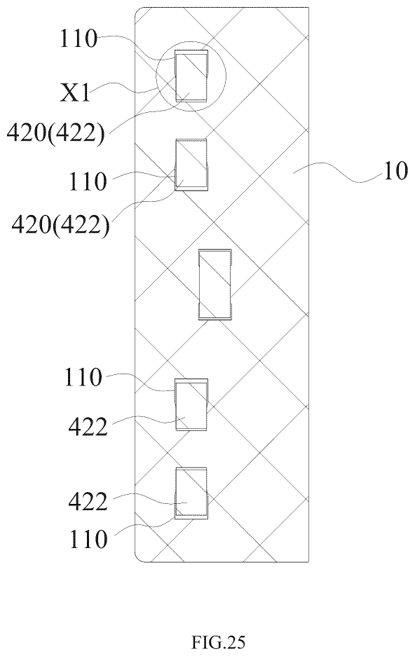

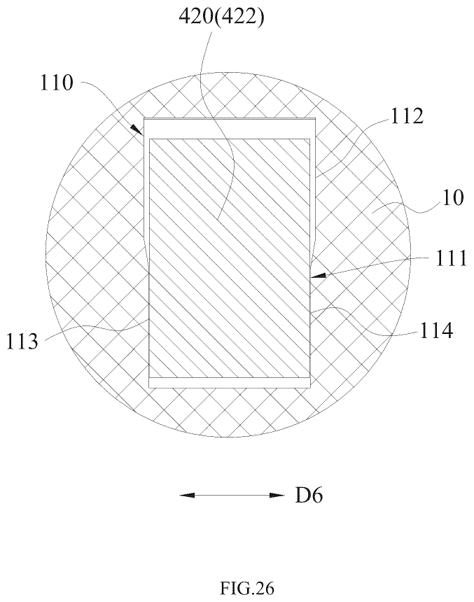

As shown in FIGS. 25 and 26, FIG. 25 shows a cross-sectional view along H-H of FIG. 20. FIG. 26 shows an enlarged view of the area X1 in FIG. 25. The base 10 has a mounting hole 110 that penetrates its inner surface and the bottom surface 101. The wall of the mounting hole 110 has a positioning wall structure 111 and a gap wall structure 112. The static contact piece 420 is inserted through the mounting hole 110. Part of the outer surface of the static contact piece 420 abuts against the positioning wall structure 111, and another part of the outer surface of the static contact piece 420 has a gap with the gap wall structure 112. The gap is filled with positioning glue.

The wall of the mounting hole 110 in the base 10 has a positioning wall structure 111 and a gap wall structure 112. When the static contact piece 420 is assembled with the base 10, the static contact piece 420 is inserted through the mounting hole 110. On one hand, part of the outer surface of the static contact piece 420 abuts against the positioning wall structure 111, thereby achieving preliminary positioning of the static contact piece 420. On the other hand, there is a gap between another part of the outer surface of the static contact piece 420 and the gap wall structure 112, allowing positioning glue to be filled into this gap, further strengthening the positioning strength between the static contact piece 420 and the base 10.

It can be seen that in this embodiment of the relay, the static contact piece 420 is preliminarily positioned by the positioning wall structure 111 of the mounting hole 110, and then the gap between the static contact piece 420 and the gap wall structure 112 of the mounting hole 110 is filled with positioning glue to complete the sealed assembly between the static contact piece 420 and the base 10. Compared with the relevant technology, this embodiment reduces one step of glue application, effectively reducing costs and improving assembly efficiency.

As an example, the base 10 has mounting holes 110 corresponding to the two lead-out terminals 422 of the static contact piece 420. The two lead-out terminals 422 are inserted through the two mounting holes 110, respectively, and each lead-out terminal 422 abuts against the positioning wall structure 111 of the corresponding mounting hole 110 and has a gap with the gap wall structure 112.

The positioning wall structure 111 includes a first positioning wall 113 and a second positioning wall 114. The first positioning wall 113 and the second positioning wall 114 are arranged away from each other along a positioning direction D6. By contacting the lead-out terminal 422 of the static contact piece 420 with the first positioning wall 113 and the second positioning wall 114, the degree of freedom of the static contact piece 420 and the base 10 in the positioning direction D6 is limited.

The positioning direction D6 can be the movement direction D3 of the push rod mechanism.

It can be understood that the shapes of the first positioning wall 113 and the second positioning wall 114 are adapted to the outer contour shape of the lead-out terminal 422. For example, when the cross-sectional shape of the lead-out terminal 422 is rectangular, the first positioning wall 113 and the second positioning wall 114 can be planar. Of course, in other embodiments, when the cross-sectional shape of the lead-out terminal 422 is circular, the shapes of the first positioning wall 113 and the second positioning wall 114 can also be curved surfaces.

The lead-out terminal 422 of the static contact piece 420 is in interference fit with the positioning wall structure 111. In this embodiment, the lead-out terminal 422 is positioned with both the first positioning wall 113 and the second positioning wall 114.

It can be understood that the various embodiments/implementations provided in this disclosure can be combined with each other without contradiction, and will not be listed one by one here.

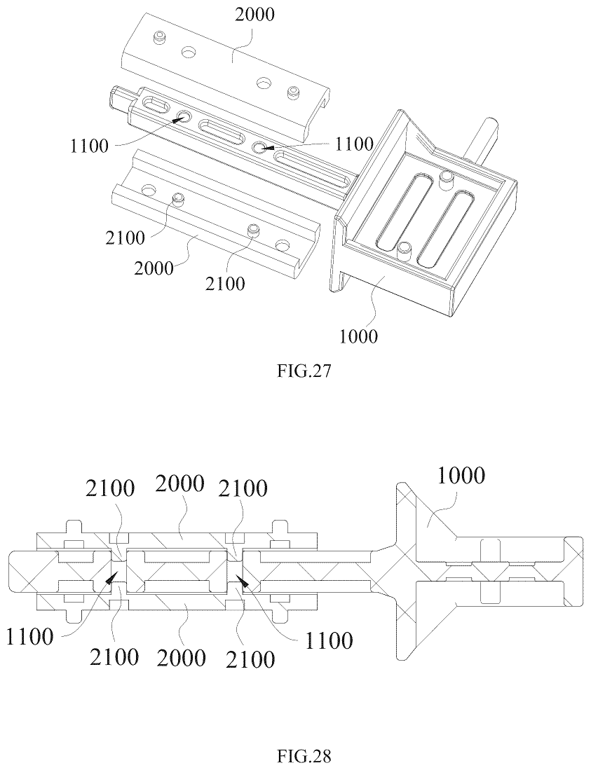

As shown in FIGS. 27 and 28, in the relevant technology, the push rod mechanism of the relay includes a push rod 1000 and two iron cores 2000. The push rod 1000 is made of plastic material and has a perforation 1100. The iron core 2000 is made of metal material and has a protrusion 2100. When the two iron cores 2000 are assembled with the push rod 1000, the protrusion 2100 of each iron core 2000 is inserted into the perforation 1100, and the protrusion 2100 is in interference fit with the perforation 1100.

However, since the push rod 1000 is made of plastic material and the iron core 2000 is made of metal material, the interference fit between the metal protrusion 2100 and the plastic perforation 1100 is not very effective. As a result, the connection between the push rod 1000 and the iron core 2000 is not very secure and can easily loosen. When the push rod 1000 and the iron core 2000 loosen, on the one hand, the iron core 2000 contacts the inner wall of the bobbin, increasing the friction between them. On the other hand, the contact surface between the iron core 2000 and the yoke plate changes, affecting the magnetic circuit of the relay. Moreover, when the iron core 2000 has a permanent magnet on its side, under the magnetic attraction of the permanent magnet, the iron core 2000 is more likely to loosen from the push rod 1000.

This disclosure also provides a relay and a push rod mechanism that can improve the connection strength between the iron core and the push rod to prevent the iron core from detaching from the push rod.

The push rod mechanism of this embodiment of the relay includes a push rod and an iron core assembly. The push rod includes a rod portion and a mounting portion. The mounting portion is located at one end of the rod portion and is used to mount the movable contact piece of the relay. The iron core assembly is mounted on the rod portion, and a limit structure is provided between the iron core assembly and the rod portion to restrict the relative movement of the iron core assembly and the rod portion in the axial direction of the rod portion. The iron core assembly includes a first iron core and a second iron core, which are connected by a first interference structure. The first interference structure includes a first connection part formed on the first iron core and a second connection part formed on the second iron core. The first connection part and the second connection part are in interference fit.

According to some embodiments of this disclosure, the rod portion has a first through hole, and the first interference structure is inserted through the first through hole.

According to some embodiments of this disclosure, the first interference structure abuts against the inner wall of the first through hole to form the limit structure.

According to some embodiments of this disclosure, the first iron core also includes a first base plate, with the first connection part protruding from one side of the first base plate. The second iron core also includes a second base plate, with the second connection part protruding from one side of the second base plate. The first base plate and the second base plate are respectively stacked on opposite sides of the rod portion.

According to some embodiments of this disclosure, the first connection part includes a first boss and a second boss. The first boss is located at a side of the first base plate facing the rod portion, and the second boss is located at a side of the first boss away from the first base plate. The second connection part has a hole on the side away from the second base plate, the second boss is inserted into the hole and interference fit with the hole. A side of the first boss away from the first base plate abuts against the side of the second connection part away from the second base plate.

According to some embodiments of this disclosure, the hole is a through hole or a blind hole.

According to some embodiments of this disclosure, the first iron core and the second iron core are also connected by a second interference structure. The second interference structure includes a third connection part formed on the first iron core and a fourth connection part formed on the second iron core. The third connection part and the fourth connection part are in interference fit.

According to some embodiments of this disclosure, the rod portion also has a second through hole, the second interference structure is inserted into the second through hole.

According to some embodiments of this disclosure, a gap exists between the second interference structure and an inner wall of the second through hole.

According to some embodiments of this disclosure, the first iron core and the second iron core are interconnected to form a sleeve structure that is fitted over an outer periphery of the rod portion. The first interference structure is located at the outer periphery of the rod portion.

According to some embodiments of this disclosure, the sleeve structure is a fully enclosed structure or a partially enclosed structure.

According to some embodiments of this disclosure, the first connection part includes a bump, and the second connection part includes a recess. The bump is inserted into the recess and is in interference fit.

According to some embodiments of this disclosure, the limit structure includes a limit column and a limit hole. The first iron core and the second iron core both have the limit column, and the rod portion has the limit hole. The limit column is inserted through the limit hole.

According to some embodiments of this disclosure, the push rod is made of plastic material, and both the first iron core and the second iron core are made of metal material; and/or, the first iron core and the second iron core are made of same material.

The relay of this embodiment includes the push rod mechanism as described in present disclosure.

According to some embodiments of this disclosure, the relay also includes a permanent magnet. the permanent magnet is arranged at a side of the first core of the push rod mechanism facing away from the rod portion; and/or the permanent magnet is arranged at a side of the second core that facing away from the rod portion.

One embodiment of the above disclosure at least has the following advantages or beneficial effects:

In this embodiment of the push rod mechanism, the first iron core and the second iron core are connected by the first interference structure, which allows the first iron core to be interference-fitted with the second iron core, thereby making the connection between the first iron core and the second iron core more secure. On the one hand, it can prevent the iron core from contacting the inner wall of the bobbin, which may affect the movement of the push rod mechanism. On the other hand, it can ensure that the contact surface between the iron core and the yoke plate remains in its initial state, avoiding the impact on the magnetic circuit of the relay. Moreover, even if a permanent magnet is provided on the side of the iron core, the iron core is not likely to loosen from the push rod under the magnetic attraction of the permanent magnet.

The following is a detailed description in combination with the drawings.

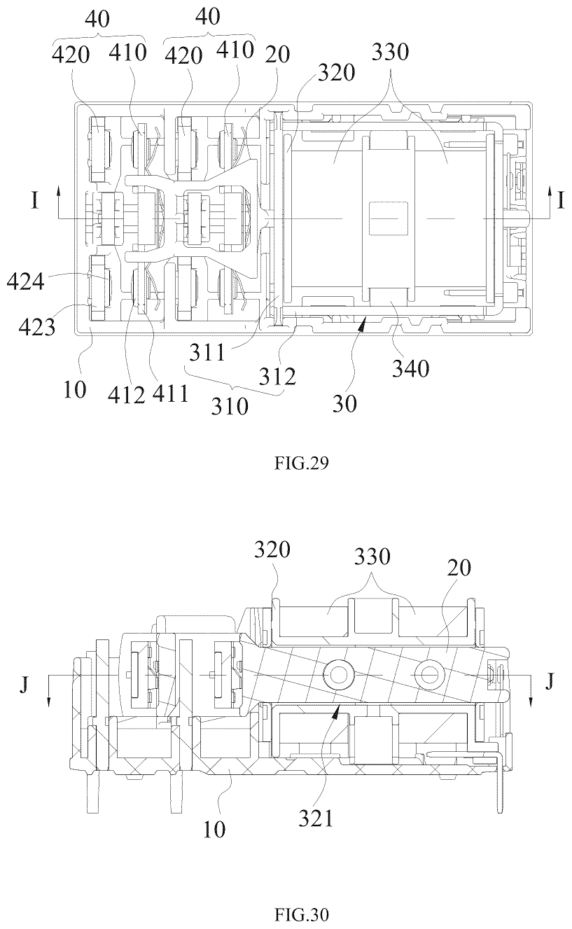

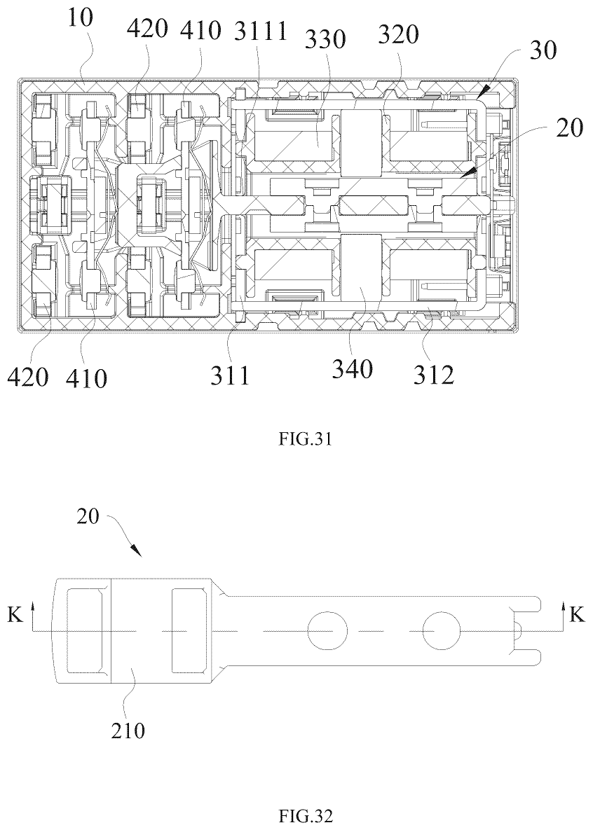

As shown in FIGS. 29 to 31, FIG. 29 shows a top view of the relay of this embodiment, with the upper cover omitted. FIG. 30 shows a cross-sectional view along I-I of FIG. 29, and FIG. 31 shows a cross-sectional view along J-J of FIG. 30. The relay of this embodiment includes a base 10, a push rod mechanism 20, a magnetic circuit mechanism 30, and a contact assembly 40. The push rod mechanism 20, magnetic circuit mechanism 30, and contact assembly 40 are mounted on the base 10. The magnetic circuit mechanism 30 controls the contact or separation of the contact assembly 40 through the push rod mechanism 20.

The magnetic circuit mechanism 30 includes a yoke structure 310, a bobbin 320, and a coil 330. The yoke structure 310 forms a chamber, and the bobbin 320 and coil 330 are both located inside the chamber of the yoke structure 310. The coil 330 is wound around the outer periphery of the bobbin 320 to form a magnetic control circuit. The bobbin 320 has a center hole 321 in the contact-separation direction of the contact assembly 40, which is used for the insertion of one end of the push rod mechanism 20.

As an example, the yoke structure 310 includes a yoke plate 311 and a U-shaped yoke 312, which are connected to form a ring. The yoke plate 311 has a through hole 3111, which is used for the insertion of the push rod mechanism 20.

Of course, in other embodiments, the yoke structure 310 may also include a cylindrical yoke and a yoke plate 311, which are connected to form a ring.

The magnetic circuit mechanism 30 also includes two permanent magnets 340, which are mounted on the bobbin 320 and located at both sides of the movement direction of the push rod mechanism 20. The bobbin 320, permanent magnets 340 are enclosed by the yoke structure 310 to form a magnetic latching circuit structure.

Of course, in other embodiments, it is also possible not to include permanent magnets 340. However, without the permanent magnets 340, the relay will not have a magnetic latching circuit structure, resulting in higher power consumption, shorter service life, and poorer overall performance stability.

Referring to FIGS. 29 to 31, the contact assembly 40 includes movable contact pieces 410 and static contact pieces 420. The static contact pieces 420 are fixedly installed on the base 10, and the movable contact pieces 410 are mounted on the push rod mechanism 20 and move with it.

In this embodiment, the contact assembly 40 consists of two sets, which are arranged along the movement direction of the push rod mechanism 20.

Of course, in other embodiments, the contact assembly 40 may also consist of one set or another number of sets.

Two ends of the movable contact piece 410 in the length direction serve as the movable contacts. The movable contacts may protrude from the other parts of the movable contact piece 410 or may be flush with the other parts. The parts of the static contact piece 420 that contact the movable contact piece 410 serve as the static contacts. The static contacts may protrude from the other parts of the static contact piece 420 or may be flush with the other parts.

As an example, the movable contact piece 410 includes a movable piece body 411 and a movable contact 412. The movable contact 412 and the movable piece body 411 are separate structures. The movable contact 412 and the movable piece body 411 can be connected by riveting, but not limited to this method. The static contact piece 420 includes a static piece body 423 and a static contact 424. The static contact 424 and the static piece body 423 are separate structures. The static contact 424 and the static piece body 423 can be connected by riveting, but not limited to this method.

Of course, in another embodiment, the movable contact 412 and the movable piece body 411 can also be an integral structure, and the static contact 424 and the static piece body 423 can be an integral structure.

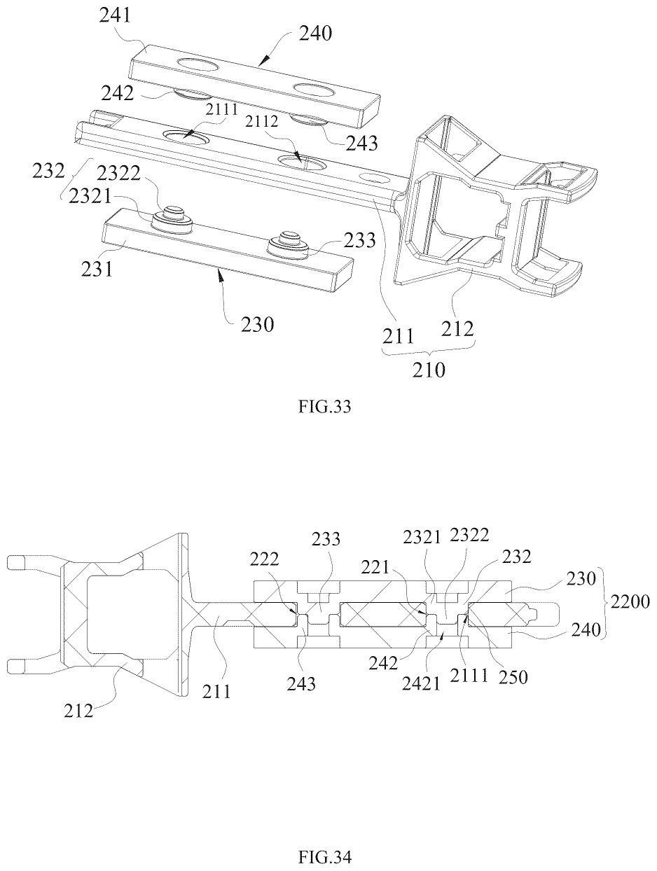

As shown in FIGS. 32 to 34, FIG. 32 shows a top view of the push rod mechanism 20 of this embodiment. FIG. 33 shows an exploded view of FIG. 32. FIG. 34 shows a cross-sectional view along K-K of FIG. 32. The push rod mechanism 20 of this embodiment includes a push rod 210 and an iron core assembly 2200. The iron core assembly 2200 is mounted on the rod portion 211, and a limit structure 250 is provided between the iron core assembly 2200 and the rod portion 211 to restrict the relative movement of the iron core assembly 2200 and the rod portion 211 in the axial direction of the rod portion 211.

The push rod 210 can be made of plastic material. The push rod 210 includes a rod portion 211 and a mounting portion 212. The mounting portion 212 is located at one end of the rod portion 211 and is used to mount the movable contact piece 410 of the relay. The rod portion 211 is inserted through the through hole 3111 of the yoke plate 311.

The iron core assembly 2200 includes a first iron core 230 and a second iron core 240. Both the first iron core 230 and the second iron core 240 are made of metal material. The materials of the first iron core 230 and the second iron core 240 can be the same or different. By setting the iron core assembly 2200 as separate first iron core 230 and second iron core 240, the assembly of the iron core assembly 2200 with the push rod 210 is more convenient and cost-effective.

The first iron core 230 and the second iron core 240 are connected by a first interference structure 221. The first interference structure 221 includes a first connection part 232 formed on the first iron core 230 and a second connection part 242 formed on the second iron core 240. The first connection part 232 and the second connection part 242 are in interference fit.

In this embodiment of the push rod mechanism 20, the first iron core 230 and the second iron core 240 are connected by the first interference structure 221, which allows the first iron core 230 and the second iron core 240 to be tightly connected. On the one hand, it can prevent the iron core from contacting the inner wall of the bobbin, which may affect the movement of the push rod mechanism. On the other hand, it can ensure that the contact surface between the iron core and the yoke plate remains in its initial state, avoiding the impact on the magnetic circuit of the relay. Moreover, even if a permanent magnet is provided on the side of the iron core, the iron core is not likely to loosen from the push rod under the magnetic attraction of the permanent magnet.

The rod portion 211 has a first through hole 2111, through which the first interference structure 221 is inserted. The first interference structure 221 abuts against the inner wall of the first through hole 2111 to form the limit structure 250.

In this embodiment, the first interference structure 221 not only connects the first iron core 230 and the second iron core 240 but also abuts against the inner wall of the first through hole 2111 to serve as a positioning function. Specifically, the outer diameter of the first interference structure 221 is substantially equal to the hole diameter of the first through hole 2111, allowing the first interference structure 221 to be inserted into the first through hole 2111 while contacting its inner wall. When the first iron core 230 and the second iron core 240 are driven by the magnetic circuit of the coil 330 to move, the first interference structure 221 can drive the push rod 210 to move accordingly.

It can be understood that the shape of the first through hole 2111 can have various embodiments. For example, the first through hole 2111 can be a round hole, a rectangular hole, an elliptical hole, etc. Correspondingly, the outer contour shape of the first interference structure 221 is adapted to the shape of the first through hole 2111.

The first iron core 230 and the second iron core 240 are also connected by a second interference structure 222. The second interference structure 222 includes a third connection part 233 formed on the first iron core 230 and a fourth connection part 243 formed on the second iron core 240. The third connection part 233 and the fourth connection part 243 are in interference fit.

Between the first iron core 230 and the second iron core 240, there are two interference fit positions, namely the first interference structure 221 and the second interference structure 222. These two interference fit positions further enhance the connection strength between the first iron core 230 and the second iron core 240, preventing the iron core from detaching from the push rod 210. At the same time, these two interference fit positions also prevent the iron core from rotating relative to the push rod 210.

The rod portion 211 also has a second through hole 2112, through which the second interference structure 222 is inserted. There is a gap between the second interference structure 222 and the inner wall of the second through hole 2112. The hole diameter of the second through hole 2112 is larger than the outer diameter of the second interference structure 222, allowing a gap between them to avoid over-positioning that may lead to the inability to meet the machining requirements of the iron core or the inability to normally install the iron core with the push rod 210.

It can be understood that the relative positions of the first through hole 2111 and the second through hole 2112 can be: the second through hole 2112 is arranged along the axial direction of the rod portion 211 relative to the first through hole 2111, but not limited to this.

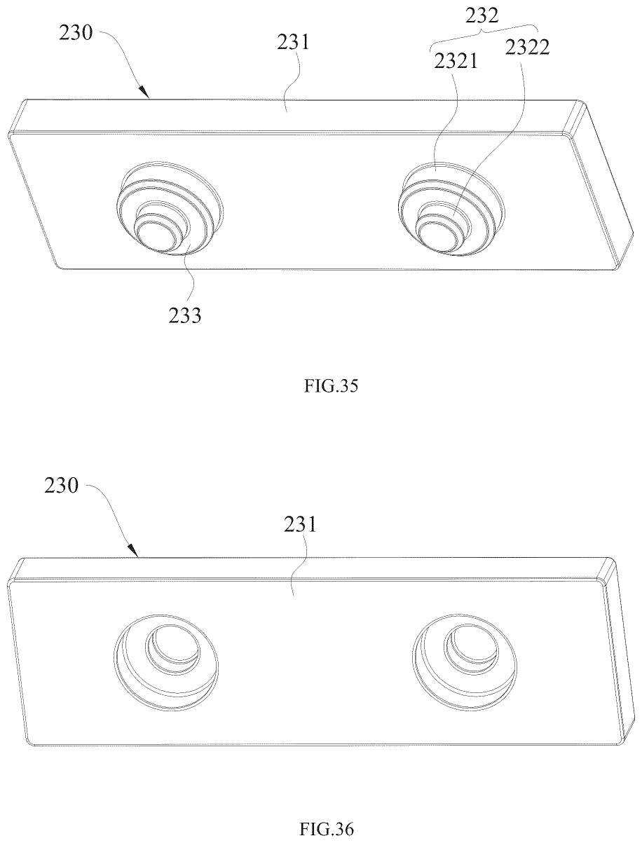

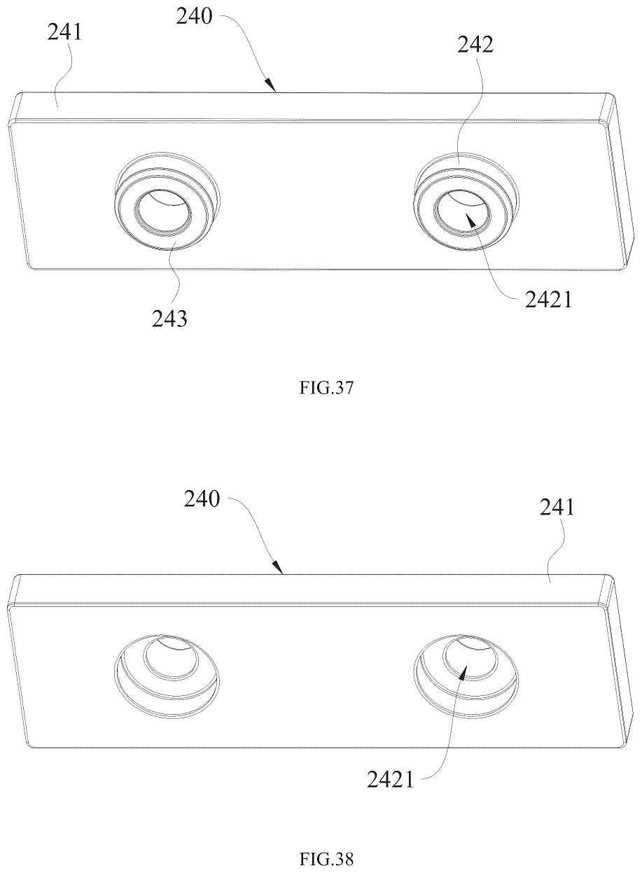

As shown in FIGS. 35 to 38, FIGS. 35 and 36 show schematic diagrams of the first iron core 230 from two different perspectives. FIGS. 37 and 38 show schematic diagrams of the second iron core 240 from two different perspectives. The first iron core 230 also includes a first base plate 231, with the first connection part 232 protruding from one side of the first base plate 231. The second iron core 240 also includes a second base plate 241, with the second connection part 242 protruding from one side of the second base plate 241. The first base plate 231 and the second base plate 241 are respectively stacked on opposite sides of the rod portion 211. As an example, the first base plate 231 and the second base plate 241 are respectively stacked on opposite sides of the rod portion 211 along the length direction of the movable contact piece 410.

The first connection part 232 includes a first boss 2321 and a second boss 2322. The first boss 2321 is located at the side of the first base plate 231 facing the rod portion 211, and the second boss 2322 is located at the side of the first boss 2321 away from the first base plate 231. The second connection part 242 has a hole 2421 on the side away from the second base plate 241. The second boss 2322 is inserted into the hole 2421 and is in interference fit with the hole 2421. The side of the first boss 2321 away from the first base plate 231 abuts against the side of the second connection part 242 away from the second base plate 241.

It can be understood that the hole 2421 can be a through hole or a blind hole.

It should be noted that the structure of the third connection part 233 can be the same as that of the first connection part 232, and the structure of the fourth connection part 243 can be the same as that of the second connection part 242, which will not be repeated here.

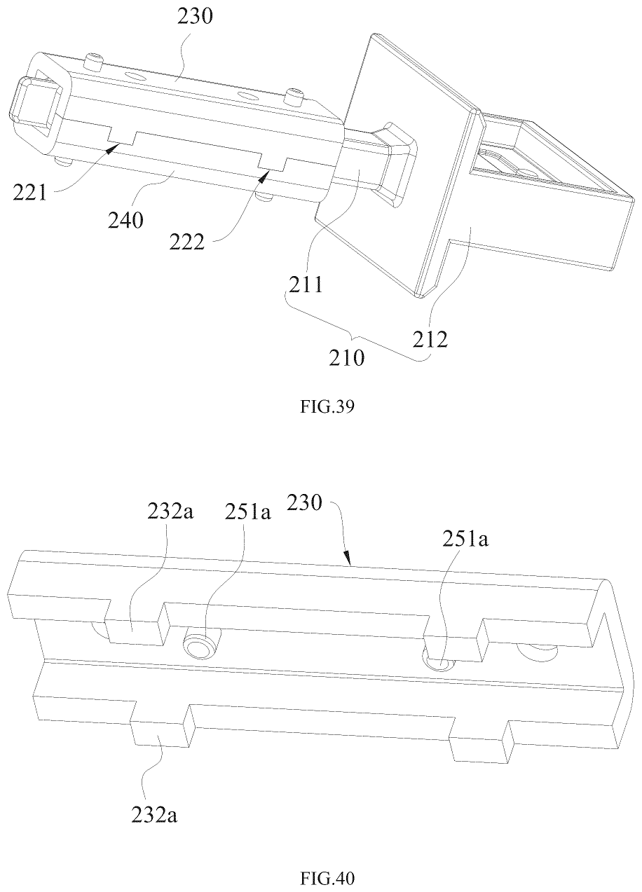

As shown in FIGS. 39 to 41, FIG. 39 shows a schematic diagram of another embodiment of the push rod mechanism 20. FIG. 40 shows a schematic diagram of the first iron core 230 in FIG. 39. FIG. 41 shows a schematic diagram of the second iron core 240 in FIG. 39. The similarities between this embodiment of the push rod mechanism 20 and the push rod mechanism 20 shown in FIG. 32 will not be repeated here. The differences are as follows:

Both the first iron core 230 and the second iron core 240 are U-shaped. The first iron core 230 and the second iron core 240 are interconnected to form a sleeve structure that is fitted over the outer periphery of the rod portion 211. The first iron core 230 and the second iron core 240 are connected by the first interference structure 221, which is located at the outer periphery of the rod portion 211.

As an example, the first connection part 232 includes a bump 232a, and the second connection part 242 includes a recess 242a. The bump 232a is inserted into the recess 242a and is in interference fit.

The limit structure 250 includes a limit column 251a and a limit hole (not shown in the drawings). Both the first iron core 230 and the second iron core 240 have the limit column 251a, and the rod portion 211 has the limit hole. The limit column 251a is inserted through the limit hole. The limit hole can be a through hole or a blind hole.

The first interference structure 221 can be two in number, with the two first interference structures 221 symmetrically arranged along the axis of the rod portion 211.

Of course, it can be understood that a second interference structure 222 can also be provided between the first iron core 230 and the second iron core 240, and the second interference structure 222 can also have a bump 232a and a recess 242a in interference fit.

The second interference structure 222 can also be two in number, with the two second interference structures 222 symmetrically arranged along the axis of the rod portion.

As an example, the first iron core 230 and the second iron core 240 are interconnected to form a fully enclosed sleeve structure. That is to say, in the circumferential direction of the sleeve structure, the sleeve structure continuously surrounds the outer periphery of the rod portion 211.

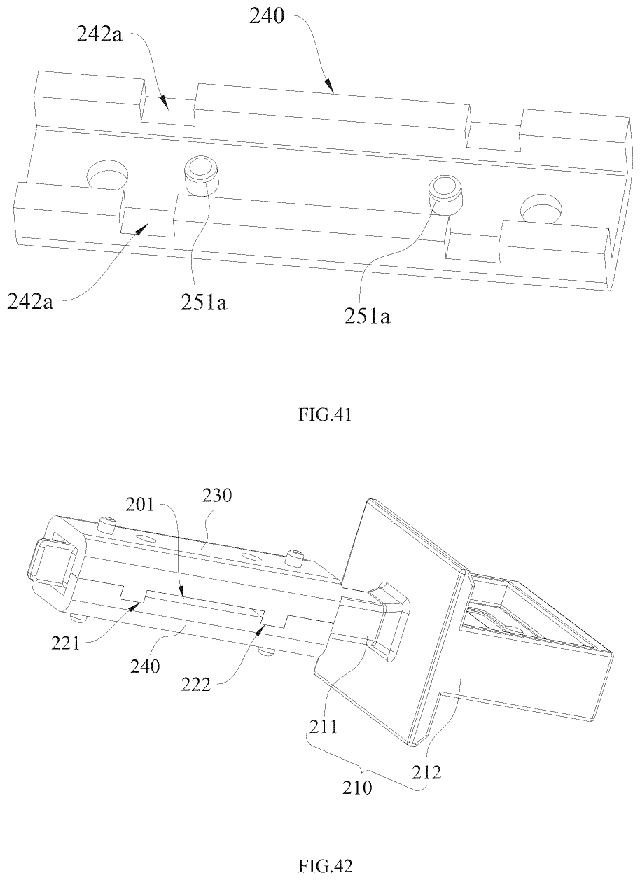

As shown in FIG. 42, FIG. 42 shows a schematic diagram of another embodiment of the push rod mechanism. The similarities between this embodiment of the push rod mechanism 20 and the push rod mechanism 20 shown in FIG. 39 will not be repeated here. The differences are as follows:

The first iron core 230 and the second iron core 240 are interconnected to form a partially enclosed sleeve structure. Specifically, the sleeve structure has a cutout 201, and a part of the rod portion 211 corresponding to the cutout 201 is exposed on the outer peripheral surface of the sleeve structure through the cutout 201.

It can be understood that the shape of the cutout 201 is not specifically limited. For example, the shape of the cutout 201 can be rectangular, and the rectangular cutout 201 can extend along the axial direction of the rod portion 211.

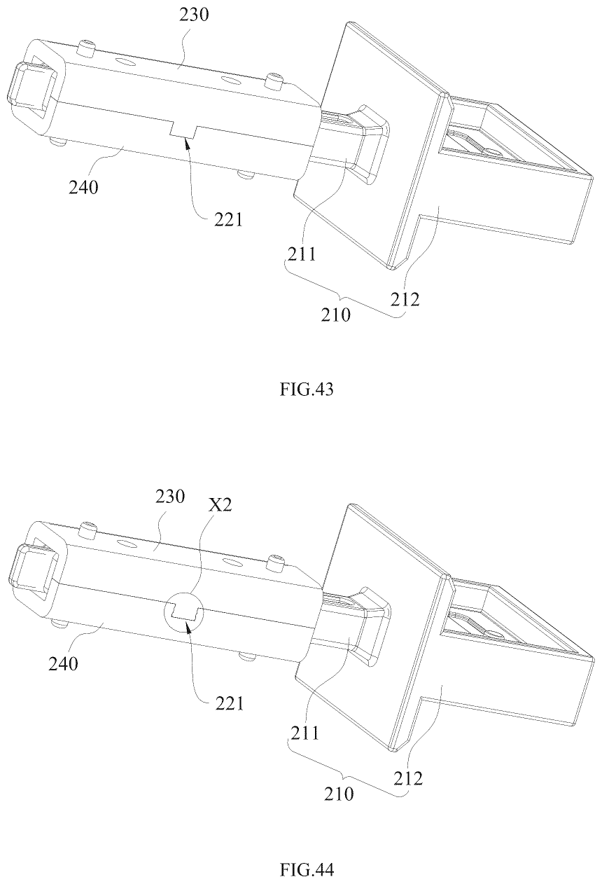

The cutout 201 can be formed at the connection between the first iron core 230 and the second iron core 240. Of course, the cutout 201 can also be formed on the first iron core 230 or the second iron core 240. As shown in FIG. 43, FIG. 43 shows a schematic diagram of another embodiment of the push rod mechanism. The similarities between this embodiment of the push rod mechanism 20 and the push rod mechanism 20 shown in FIG. 39 will not be repeated here. The differences are as follows:

The first iron core 230 and the second iron core 240 are connected by the first interference structure 221, but not by the second interference structure 222.

As shown in FIGS. 44 and 45, FIG. 44 shows a schematic diagram of another embodiment of the push rod mechanism. FIG. 45 shows an enlarged view of the area X2 in FIG. 44. The similarities between this embodiment of the push rod mechanism 20 and the push rod mechanism 20 shown in FIG. 43 will not be repeated here. The differences are as follows:

The interference fit structure between the bump 232a and the recess 242a can be of any shape. For example, the outer surface of the bump 232a has a concave-convex surface, and the wall of the recess 242a has a concave-convex structure that is adapted to the outer surface of the bump 232a.

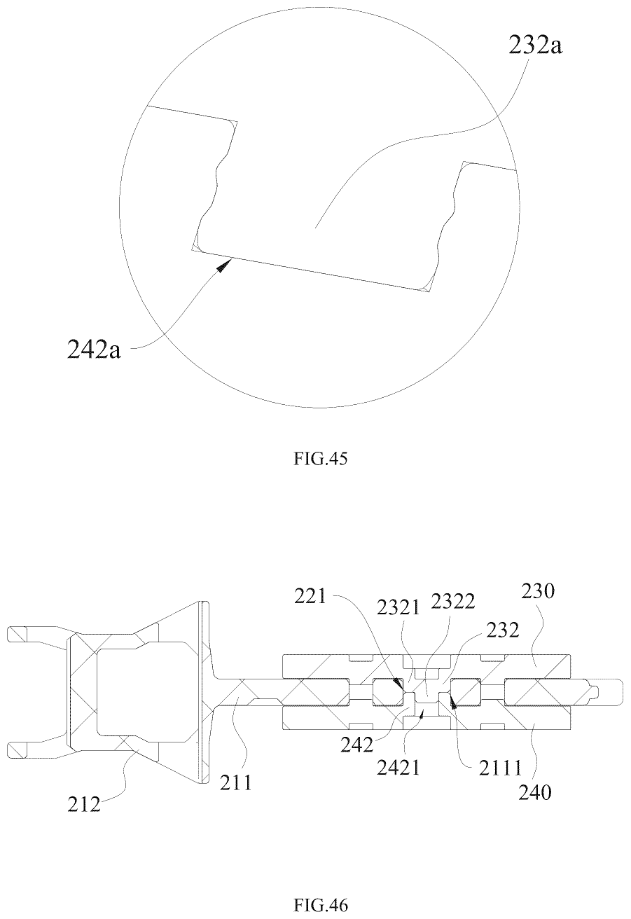

As shown in FIG. 46, FIG. 46 shows a cross-sectional view of another embodiment of the push rod mechanism. The similarities between this embodiment of the push rod mechanism 20 and the push rod mechanism 20 shown in FIG. 32 will not be repeated here. The differences are as follows:

The first iron core 230 and the second iron core 240 are connected by the first interference structure 221, but not by the second interference structure 222.

It can be understood that the various embodiments/implementations provided in this disclosure can be combined with each other without contradiction, and will not be listed one by one here.

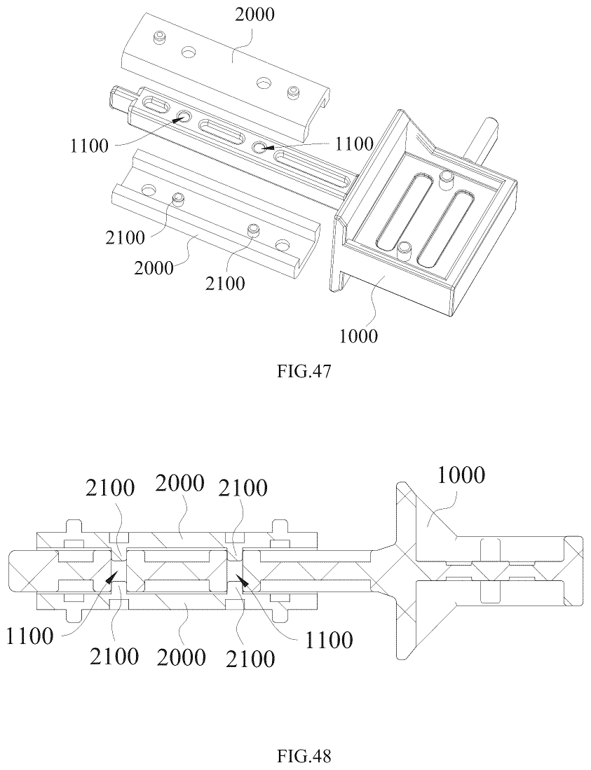

As shown in FIGS. 47 and 48, the push rod mechanism of the relay in the relevant technology includes a push rod 1000 and two iron cores 2000. The push rod 1000 is made of plastic material and has a perforation 1100. Each iron core 2000 is made of metal material and has a protrusion 2100. When the two iron cores 2000 are assembled with the push rod 1000, the protrusion 2100 of each iron core 2000 is inserted into the perforation 1100, and the protrusion 2100 is in interference fit with the perforation 1100.

However, since the push rod 1000 is made of plastic material and the iron core 2000 is made of metal material, the interference fit between the metal protrusion 2100 and the plastic perforation 1100 is not very effective. As a result, the connection between the push rod 1000 and the iron core 2000 is not very secure and can easily loosen. When the push rod 1000 and the iron core 2000 loosen, on the one hand, the iron core 2000 contacts the inner wall of the bobbin, increasing the friction between them. On the other hand, the contact surface between the iron core 2000 and the yoke plate changes, affecting the magnetic circuit of the relay. Moreover, when the side of the iron core 2000 has a permanent magnet, under the magnetic attraction of the permanent magnet, the iron core 2000 is more likely to loosen from the push rod 1000.

This disclosure also provides a relay and a push rod mechanism that can improve the connection strength between the iron core and the push rod to prevent the iron core from loosening from the push rod.

The push rod mechanism of the relay of this embodiment includes a push rod, an iron core, and an anti-loosening structure. The push rod includes a rod portion and a mounting portion. The mounting portion is located at an end of the rod portion and is used to mount the movable contact piece of the relay. The iron core is connected to the rod portion, and a limit structure is provided between the iron core and the rod portion to restrict the relative movement of the iron core and the rod portion in the axial direction of the rod portion. The anti-loosening structure is located between the iron core and the rod portion and includes a first through hole and an anti-loosening member. The first through hole is provided in the iron core and extends through a surface of the iron core facing the rod portion and a surface away from the rod portion. The anti-loosening member includes a first penetrating portion and a cover portion. The first penetrating portion is connected to the rod portion and extends through the first through hole. The cover portion is connected to the first penetrating portion and is located at a side of the iron core away from the rod portion. The cover portion covers at least a part of a periphery of the first through hole to prevent the iron core from loosening from the rod portion.

According to some embodiments of this disclosure, the rod portion has a perforation corresponding to a position of the first through hole, and the first penetrating portion extends through the first through hole and the perforation.

According to some embodiments of this disclosure, the anti-loosening member is a rivet.

According to some embodiments of this disclosure, the outer peripheral surface of the first penetrating portion abuts against the inner wall of the perforation to form the limit structure.

According to some embodiments of this disclosure, a side of the iron core away from the rod portion has a first countersink, the first through hole extends through the bottom of the first countersink, and the cover portion is accommodated in the first countersink.

According to some embodiments of this disclosure, the anti-loosening member is an integral structure with the rod portion.

According to some embodiments of this disclosure, the cover portion is a latch hook, and the anti-loosening member is latched to the iron core.

According to some embodiments of this disclosure, the limit structure includes:
a limit protrusion, provided on one of the iron core and the rod portion;
a limit recess, provided on another of the iron core and the rod portion, the limit protrusion is insertable into the limit recess.

According to some embodiments of this disclosure, an inner wall of the first through hole has a first guiding surface at a junction with the surface of the iron core facing the rod portion, and the cover portion has a second guiding surface. The second guiding surface is slidable against the first guiding surface.

According to some embodiments of this disclosure, the iron core and the push rod are integrally injection-molded.

According to some embodiments of this disclosure, the anti-loosening structure also includes a second through hole provided in the iron core, the second through hole extends through the surface of the iron core facing the rod portion and the surface away from the rod portion;

the anti-loosening member also includes a second penetrating portion, the second penetrating portion is connected to the rod portion and passing through the second through hole, the cover portion is connected to the first penetrating portion and the second penetrating portion.

According to some embodiments of this disclosure, a side of the iron core away from the rod portion has a second countersink, the first through hole and the second through hole both communicating with the second countersink;
the cover portion is located in the second countersink.

According to some embodiments of this disclosure, a surface of the cover portion away from the rod portion is flush with a surface of the iron core away from the rod portion.

The relay of this embodiment includes the push rod mechanism as described in any of the above embodiments.

According to some embodiments of this disclosure, the relay also includes a permanent magnet, the permanent magnet is disposed at the side of the iron core of the push rod mechanism away from the rod portion.

One embodiment of the above disclosure at least has the following advantages or beneficial effects:

The push rod mechanism of this embodiment of the relay has an anti-loosening structure between the rod portion and the iron core. The first penetrating portion of the anti-loosening structure is connected to the rod portion and extends through the first through hole of the iron core. The cover portion is connected to the first penetrating portion and covers at least a part of the periphery of the first through hole. In this way, the cover portion can prevent the iron core from loosening from the rod portion. On the one hand, it can prevent the iron core from contacting the inner wall of the bobbin, which may affect the movement of the push rod mechanism. On the other hand, it can ensure that the contact surface between the iron core and the yoke plate remains in its initial state, avoiding the impact on the magnetic circuit of the relay. Moreover, even if a permanent magnet is provided at the side of the iron core, the iron core is not likely to loosen from the push rod under the magnetic attraction of the permanent magnet.

As shown in FIGS. 49 to 51, FIG. 49 shows a top view of the relay of this embodiment, with the upper cover omitted. FIG. 50 shows a cross-sectional view along L-L of FIG. 49, and FIG. 51 shows a cross-sectional view along M-M of FIG. 50. The relay of this embodiment includes a base 10, a push rod mechanism 20, a magnetic circuit mechanism 30, and a contact assembly 40. The push rod mechanism 20, magnetic circuit mechanism 30, and contact assembly 40 are mounted on the base 10. The magnetic circuit mechanism 30 controls the contact or separation of the contact assembly 40 through the push rod mechanism 20.

The magnetic circuit mechanism 30 includes a yoke structure 310, a bobbin 320, and a coil 330. The yoke structure 310 forms a chamber, and both the bobbin 320 and the coil 330 are located inside the chamber of the yoke structure 310. The coil 330 is wound around the outer periphery of the bobbin 320 to form a magnetic control circuit. The bobbin 320 has a center hole 321 in the contact-separation direction of the contact assembly 40, which is used for the insertion of one end of the push rod mechanism 20.

As an example, the yoke structure 310 includes a yoke plate 311 and a U-shaped yoke 312, which are connected to form a ring. The yoke plate 311 has a through hole 3111, which is used for the insertion of the push rod mechanism 20.

Of course, in other embodiments, the yoke structure 310 may also include a cylindrical yoke and a yoke plate 311, which are connected to form a ring.

The magnetic circuit mechanism 30 also includes two permanent magnets 340, which are mounted on the bobbin 320 and located at both sides of the movement direction of the push rod mechanism 20. The two permanent magnets 340 form a magnetic latching circuit structure. The two permanent magnets 340 form a magnetic latching circuit structure, which is advantageous for reducing power consumption, extending service life, and improving stability.

Of course, in other embodiments, it is also possible not to include permanent magnets 340.

Referring to FIGS. 49 to 51, the contact assembly 40 includes movable contact pieces 410 and static contact pieces 420. The static contact pieces 420 are fixedly installed on the base 10, and the movable contact pieces 410 are mounted on the push rod mechanism 20 and move with it.

In this embodiment, the contact assembly 40 consists of two sets, which are arranged along the movement direction of the push rod mechanism 20.

Of course, in other embodiments, the contact assembly 40 may also consist of one set or another number of sets.

Two ends of the movable contact piece 410 in the length direction ends serve as the movable contacts. The movable contacts may protrude from the other parts of the movable contact piece 410 or may be flush with the other parts. The parts of the static contact piece 420 that contact the movable contact piece 410 serve as the static contacts. The static contacts may protrude from the other parts of the static contact piece 420 or may be flush with the other parts.

As an example, the movable contact piece 410 includes a movable piece body 411 and a movable contact 412. The movable contact 412 and the movable piece body 411 are separate structures. The movable contact 412 and the movable piece body 411 can be connected by riveting, but not limited to this method. The static contact piece 420 includes a static piece body 423 and a static contact 424. The static contact 424 and the static piece body 423 are separate structures. The static contact 424 and the static piece body 423 can be connected by riveting, but not limited to this method.

Of course, in another embodiment, the movable contact 412 and the movable piece body 411 can also be an integral structure, and the static contact 424 and the static piece body 423 can be an integral structure.

The push rod mechanism 20 is movable relative to the base 10. The push rod mechanism 20 includes a push rod 210 and an iron core 220, with the iron core 220 connected to the push rod 210. Under the action of the magnetic control circuit formed by the coil 330, the iron core 220 can move in the direction of contact or separation of the contacts, thereby driving the push rod 210 to move and controlling the contact or separation of the contacts of the contact assembly 40. The movable contact piece 410 of the contact assembly 40 is mounted on the push rod 210.

It can be understood that the number of iron cores 220 in this disclosure can be one, two, or more. In this embodiment of the disclosure, the number of iron cores 220 is two, with the two iron cores 220 is located at opposite sides of the push rod 210. Two separate iron cores 220 are more convenient for assembly with the push rod 210 and are lower in cost.

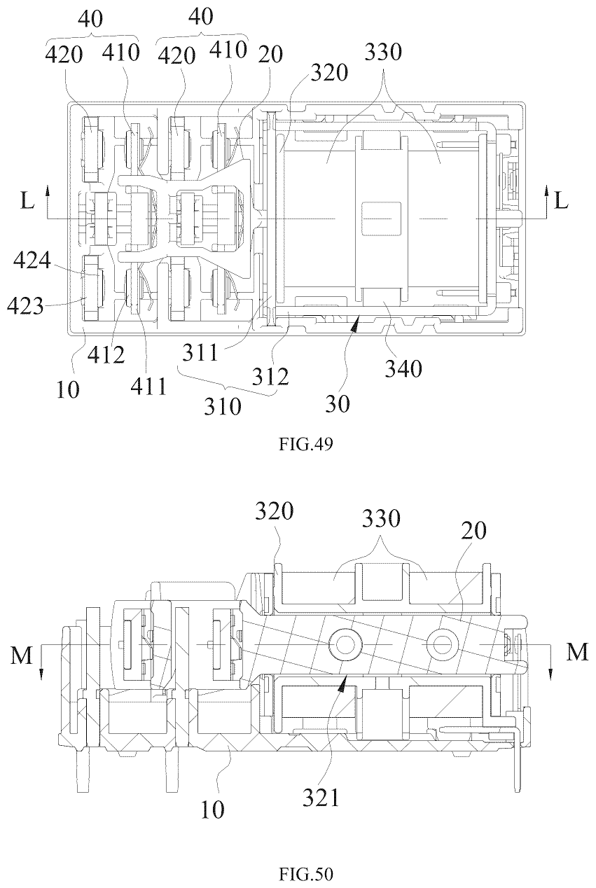

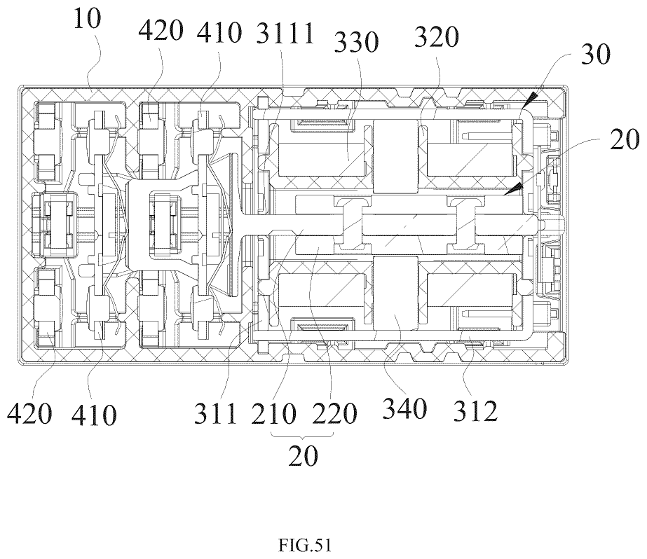

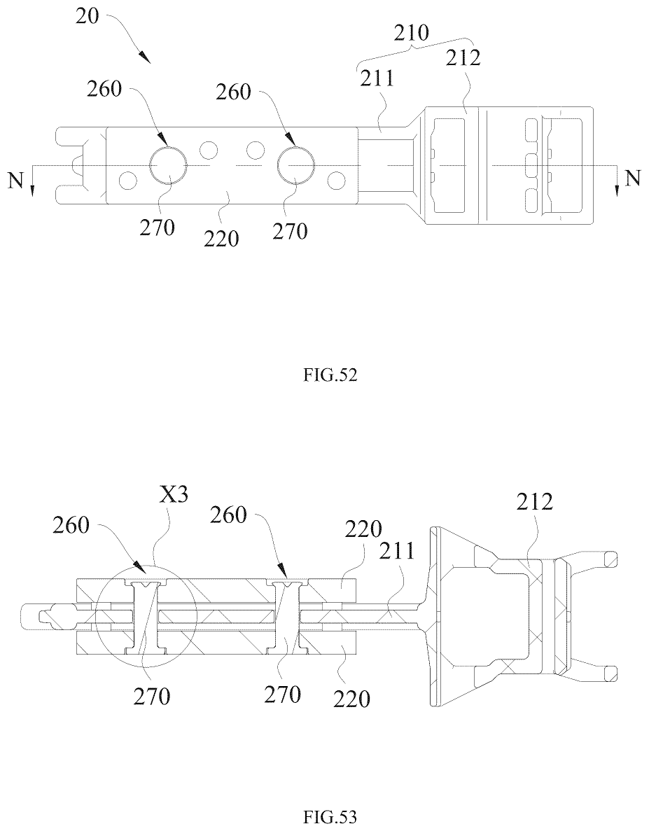

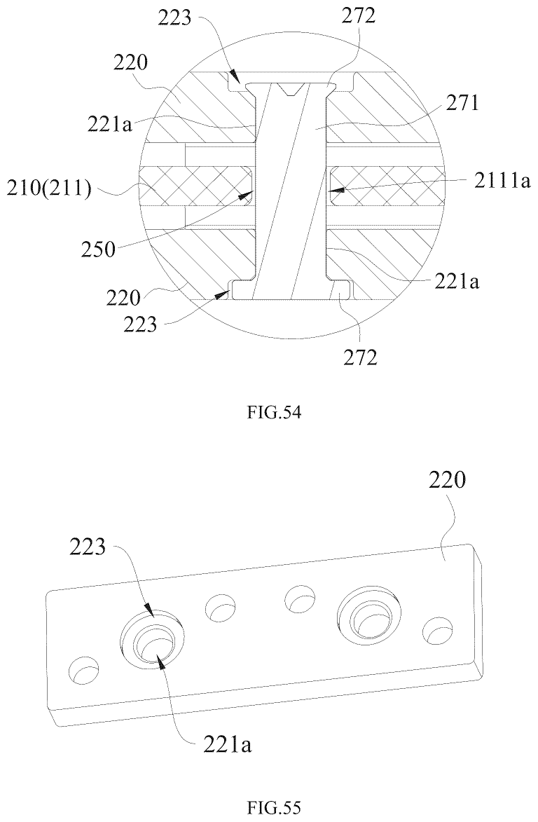

As shown in FIGS. 52 to 55, FIG. 52 shows a schematic diagram of the push rod mechanism 20 of the first embodiment of this disclosure. FIG. 53 shows a cross-sectional view along N-N of FIG. 52. FIG. 54 shows an enlarged view of the area X3 in FIG. 53. FIG. 55 shows a schematic diagram of the iron core 220 in FIG. 52. The push rod mechanism 20 includes a push rod 210, an iron core 220, and an anti-loosening structure 260.

The push rod 210 can be made of plastic material. The push rod 210 includes a rod portion 211 and a mounting portion 212. The mounting portion 212 is located at one end of the rod portion 211 and is used to mount the movable contact piece 410 of the relay. The rod portion 211 extends through the through hole 3111 of the yoke plate 311. The iron core 220 is connected to the rod portion 211, and a limit structure 250 is provided between the iron core 220 and the rod portion 211 to restrict the relative movement of the iron core 220 and the rod portion 211 in the axial direction of the rod portion 211.

The anti-loosening structure 260 is located between the iron core 220 and the rod portion 211. The anti-loosening structure 260 includes a first through hole 221a and an anti-loosening member 270. The first through hole 221a is provided in the iron core 220 and extends through the surface of the iron core 220 facing the rod portion 211 and the surface away from the iron core 220. The anti-loosening member 270 includes a first penetrating portion 271 and a cover portion 272. The first penetrating portion 271 is connected to the rod portion 211 and extends through the first through hole 221a. The cover portion 272 is connected to the first penetrating portion 271 and is located at the side of the iron core 220 away from the rod portion 211. The cover portion 272 covers at least a part of the periphery of the first through hole 221a to prevent the iron core 220 from loosening from the rod portion 211.

The push rod mechanism 20 of this embodiment of the relay has an anti-loosening structure 260 between the rod portion 211 and the iron core 220. The first penetrating portion 271 of the anti-loosening structure 260 is connected to the rod portion 211 and extends through the first through hole 221a of the iron core 220. The cover portion 272 is connected to the first penetrating portion 271 and covers at least a part of the periphery of the first through hole 221a. In this way, the cover portion 272 can prevent the iron core 220 from loosening from the rod portion 211. On the one hand, it can prevent the iron core 220 from contacting the inner wall of the bobbin 320, which may affect the movement of the push rod mechanism 20. On the other hand, it can ensure that the contact surface between the iron core 220 and the yoke plate 311 remains in its initial state, avoiding the impact on the magnetic circuit of the relay. Moreover, even if a permanent magnet is provided on the side of the iron core 220, the iron core 220 is not likely to loosen from the push rod 210 under the magnetic attraction of the permanent magnet.

As shown in FIGS. 52 to 55, the rod portion 211 has a perforation 2111a corresponding to the position of the first through hole 221a. The first penetrating portion 271 extends through the first through hole 221a and the perforation 2111a.

As an example, the anti-loosening member 270 is a rivet. By providing a perforation 2111a in the push rod 210 and a first through hole 221a in the iron core 220, with the positions of the perforation 2111a and the first through hole 221a corresponding to each other, the rivet can extend through the perforation 2111a and the first through hole 221a, thereby achieving a riveted connection between the iron core 220 and the push rod 210, ensuring the connection strength between the iron core 220 and the push rod 210, and preventing them from loosening.

It can be understood that, after the iron core 220 and the push rod 210 are riveted together by the rivet, the shank of the rivet can be considered as the first penetrating portion 271 of the anti-loosening member 270, and the head of the rivet can be considered as the cover portion 272 of the anti-loosening member 270.

Moreover, when the number of iron cores 220 is two, the two iron cores 220 are located at opposite sides of the rod portion 211. The rivet extends sequentially through the first through hole 221a of each iron core 220 and the perforation 2111a of the push rod 210. The head and bottom flange of the rivet can be considered as two cover portions 272, respectively, to prevent the two iron cores 220 from loosening from the rod portion 211.

Referring to FIGS. 54 and 55, the iron core 220 has a first countersink 223 at the side away from the rod portion 211. The first through hole 221a extends through the bottom of the first countersink 223, and the cover portion 272 is accommodated within the first countersink 223.

By providing a first countersink 223 at the side of the iron core 220 away from the rod portion 211, and accommodating the cover portion 272 within the first countersink 223, the anti-loosening member 270 does not protrude from the surface of the iron core 220 away from the rod portion 211. This reduces the gap between the iron core 220 and the permanent magnet 340, thereby reducing the magnetic reluctance of the magnetic circuit.

The outer peripheral surface of the first penetrating portion 271 abuts against the inner wall of the perforation 2111a to form the limit structure 250.

In this embodiment, the first penetrating portion 271 not only serves to prevent loosening but also acts as a limit structure. Specifically, the outer diameter of the first penetrating portion 271 is substantially equal to the hole diameter of the perforation 2111a, allowing the first penetrating portion 271 to be inserted into the perforation 2111a while contacting its inner wall. When the iron core 220 moves under the magnetic circuit drive of the coil, the first penetrating portion 271 can drive the push rod 210 to move accordingly.

It can be understood that the shapes of the first through hole 221a and the perforation 2111a can have various embodiments, such as circular holes, rectangular holes, elliptical holes, etc.

The number of anti-loosening structures 260 between the iron core 220 and the rod portion 211 can be one, or two or more. When the number of anti-loosening structures 260 is two or more, the anti-loosening structures 260 not only prevents the iron core 220 from loosening from the push rod 210 but also prevents the iron core 220 from rotating relative to the push rod 210. The two or more anti-loosening structures 260 can be arranged along the axial direction of the rod portion 211, of course, other arrangements are also possible.

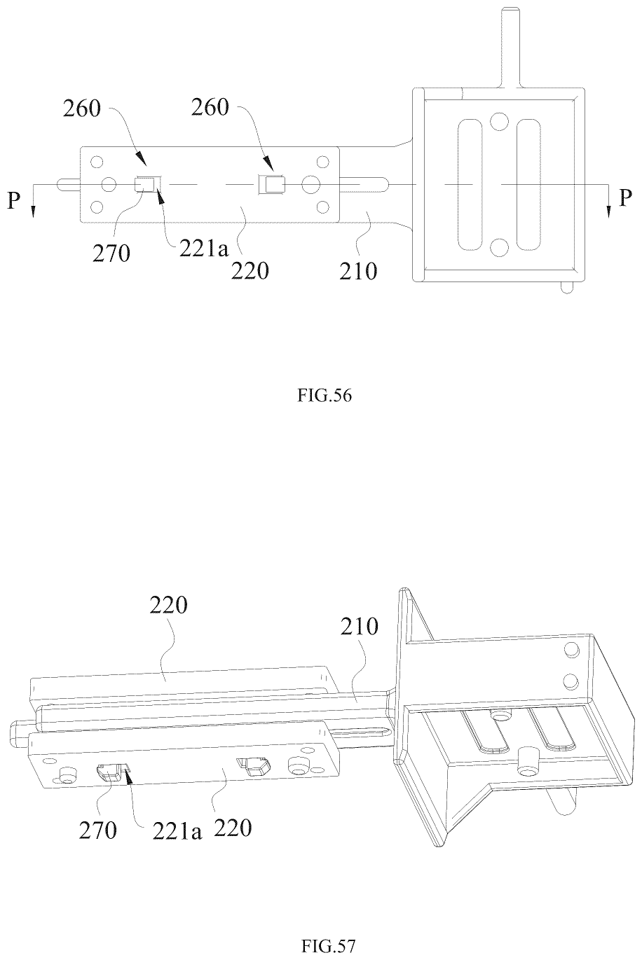

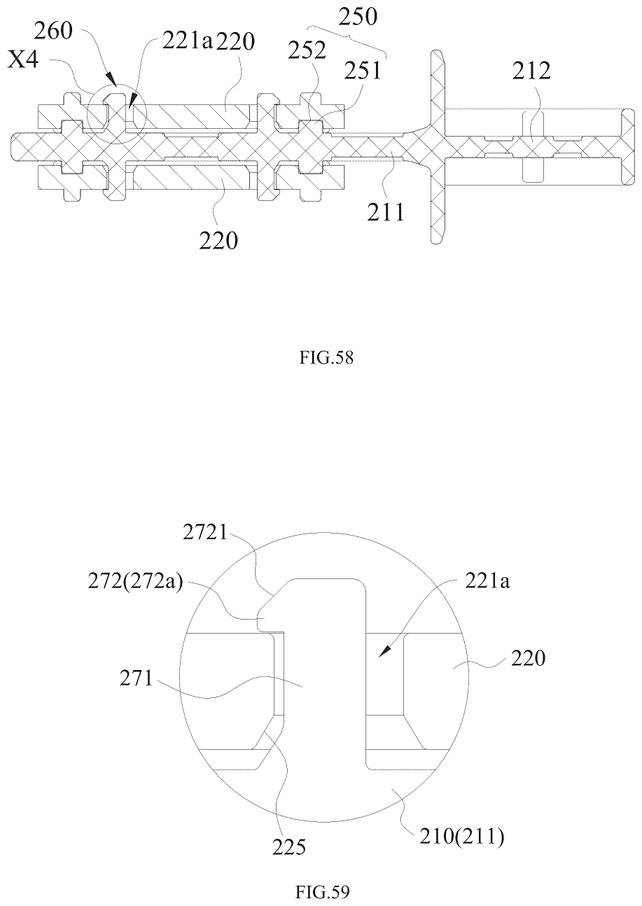

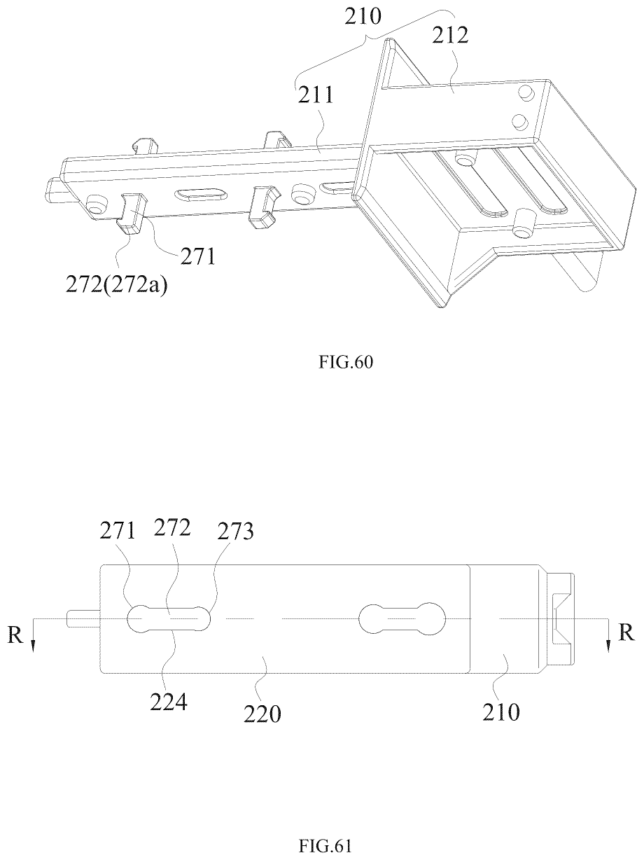

As shown in FIGS. 56 to 60, FIG. 56 shows a schematic diagram of the push rod mechanism 20 from one perspective of another embodiment of this disclosure. FIG. 57 shows a schematic diagram of the push rod mechanism 20 from another perspective of FIG. 56. FIG. 58 shows a cross-sectional view along P-P of FIG. 56. FIG. 59 shows an enlarged view of the area X4 in FIG. 58. FIG. 60 shows a schematic diagram of the push rod 210 in FIG. 56. The similarities between this embodiment of the push rod mechanism 20 and the push rod mechanism 20 shown in FIG. 52 will not be repeated here. The differences are as follows: The anti-loosening member 270 is an integral structure with the rod portion 211, and the iron core 220 is latched to the push rod 210 through the anti-loosening member 270.

Specifically, the cover portion 272 is a latch hook 272a, which is connected to the first penetrating portion 271. The first penetrating portion 271 is an integral structure with the rod portion 211 of the push rod 210. When the iron core 220 is assembled with the push rod 210, the anti-loosening member 270 is aligned with the first through hole 221a of the iron core 220, allowing the first penetrating portion 271 to pass through the first through hole 221a, and the latch hook 272a is latched to the side of the iron core 220 away from the rod portion 211.

It can be understood that, since the cover portion 272 is located at one end of the first penetrating portion 271 and the cover portion 272 needs to pass through the first through hole 221a to be located at the side of the iron core 220 away from the rod portion 211, the hole diameter of the first through hole 221a needs to be larger than the outer diameter of the first penetrating portion 271, that is, there is a gap between the outer peripheral surface of the first penetrating portion 271 and the inner wall of the first through hole 221a.

To prevent relative movement along the axis of the rod portion 211 between the iron core 220 and the push rod 210, a limit structure 250 is provided between the iron core 220 and the push rod 210. The limit structure 250 includes a limit protrusion 251 and a limit recess 252. The limit protrusion 251 is provided on one of the iron core 220 and the rod portion 211, and the limit recess 252 is provided on the other of the iron core 220 and the rod portion 211. The limit protrusion 251 is insertable into the limit recess 252 to achieve a positioning effect.

In this embodiment, the limit protrusion 251 protrudes from the surface of the rod portion 211 facing the iron core 220, and the limit recess 252 is provided on the surface of the iron core 220 facing the rod portion 211.

Of course, the limit protrusion 251 can also be provided on the iron core 220, and the limit recess 252 can be provided on the rod portion 211.

As shown in FIG. 59, the inner wall of the first through hole 221a have a first guiding surface 225 at the junction with the surface of the iron core 220 facing the rod portion 211, and the cover portion 272 has a second guiding surface 2721. The second guiding surface 2721 is slidable against the first guiding surface 225. When the anti-loosening member 270 is inserted into the first through hole 221a of the iron core 220, the first guiding surface 225 and the second guiding surface 2721 can slide against each other, facilitating the insertion of the anti-loosening member 270 into the first through hole 221a.

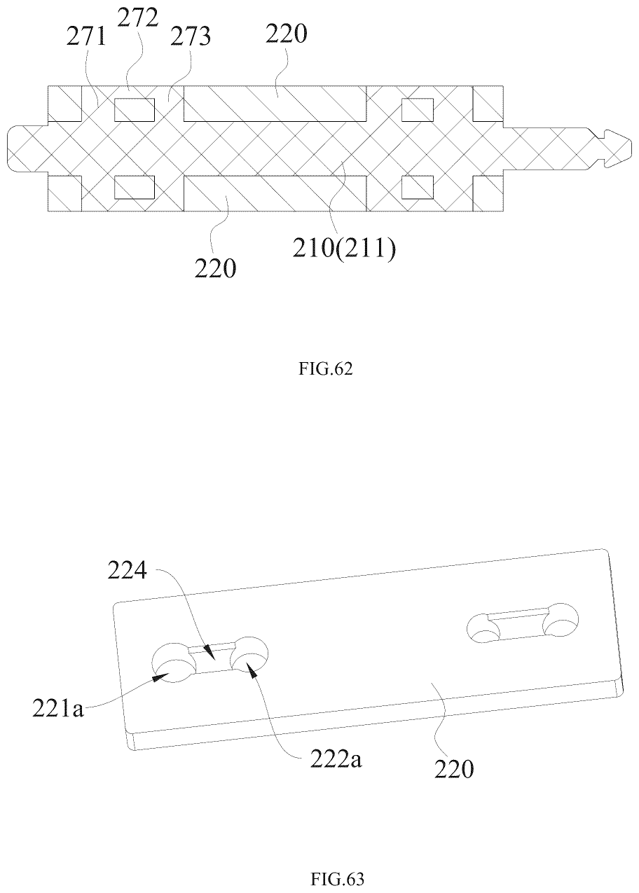

As shown in FIGS. 61 and 62, FIG. 61 shows a schematic diagram of another embodiment of the push rod mechanism 20. FIG. 62 shows a cross-sectional view along R-R of FIG. 61. FIG. 63 shows a schematic diagram of the iron core 220 in FIG. 61. The similarities between this embodiment of the push rod mechanism 20 and the above embodiments of the push rod mechanism 20 will not be repeated here. The differences are as follows: The iron core 220 is integrally injection-molded with the push rod 210.

Specifically, the anti-loosening structure 260 includes a first through hole 221a, a second through hole 222a, and an anti-loosening member 270. Both the first through hole 221a and the second through hole 222a are provided in the iron core 220 and extend through the surface of the iron core 220 facing the rod portion 211 and the surface away from the iron core 220.

The anti-loosening member 270 includes a first penetrating portion 271, a second penetrating portion 273, and a cover portion 272. The first penetrating portion 271 is connected to the rod portion 211 and extends through the first through hole 221a. The second penetrating portion 273 is connected to the rod portion 211 and extends through the second through hole 222a. The cover portion 272 is connected to the first penetrating portion 271 and the second penetrating portion 273.

In this embodiment, the cover portion 272 can be considered as bridging between the first penetrating portion 271 and the second penetrating portion 273, with both ends of the cover portion 272 connected to the first penetrating portion 271 and the second penetrating portion 273, respectively. In this way, the first penetrating portion 271, the cover portion 272, and the second penetrating portion 273 roughly form a U-shape.

As shown in FIGS. 61 and 62, the iron core 220 has a second countersink 224 at the side away from the rod portion 211. Both the first through hole 221a and the second through hole 222a communicate with the second countersink 224, and the cover portion 272 is located within the second countersink 224. The surface of the cover portion 272 away from the rod portion 211 is flush with the surface of the iron core 220 away from the rod portion 211.

Since the cover portion 272 is located within the second countersink 224, and the surface of the cover portion 272 away from the rod portion 211 is flush with the surface of the iron core 220 away from the rod portion 211, this reduces the gap between the iron core 220 and the permanent magnet 340, thereby reducing the magnetic reluctance of the magnetic circuit.

It can be understood that the various embodiments/implementations provided in this disclosure can be combined with each other without contradiction, and will not be listed one by one here.

In the disclosure embodiments, the terms “first,” “second,” “third” are used only for descriptive purposes and should not be construed as indicating or implying relative importance; the term “multiple” refers to two or more, unless otherwise specifically limited. The terms “install,” “connect,” “connect,” “fix,” etc., should be broadly understood. For example, “connect” can be a fixed connection, a detachable connection, or an integral connection; “connect” can be a direct connection or an indirect connection through an intermediate medium. For those of ordinary skill in the art, the specific meanings of the above terms in the disclosure embodiments can be understood according to the specific circumstances.

In the description of the disclosure embodiments, it should be understood that the terms “up,” “down,” “left,” “right,” “front,” “back,” etc., indicating directions or positions are based on the directions or positions shown in the drawings, and are merely for the convenience of describing the disclosure embodiments and simplifying the description, rather than indicating or implying that the device or unit referred to must have a specific direction, be constructed and operated in a specific direction, and therefore, should not be construed as limitations on the disclosure embodiments.

In the description of the disclosure embodiments, it should be understood that the terms “one embodiment,” “some embodiments,” “specific embodiment,” etc., mean that the specific features, structures, materials, or characteristics described in conjunction with the embodiment or example are included in at least one embodiment or example of the disclosure embodiments. In this specification, the schematic expressions of the above terms do not necessarily refer to the same embodiment or example. Moreover, the described specific features, structures, materials, or characteristics can be combined in any one or more embodiments or examples in a suitable manner.

The above are only the preferred embodiments of the disclosure embodiments and are not intended to limit the disclosure embodiments. For those skilled in the art, various modifications and changes can be made to the disclosure embodiments. Any modification, equivalent substitution, improvement, etc., made within the spirit and principles of the disclosure embodiments should be included within the scope of protection of the disclosure embodiments.

1-15. (canceled)

16. A relay, comprising:
a base;
a push rod mechanism comprising a push rod and an iron core, wherein the push rod comprises a mounting portion and a rod portion, the mounting portion is connected to one end of the rod portion in an axial direction, the iron core is fixedly connected to the rod portion, the push rod and the iron core can move linearly relative to the base; and
a contact assembly comprising a static contact piece and a movable contact piece, the static contact piece is fixedly connected to the base and comprises a contact terminal and a lead-out terminal, the movable contact piece is mounted on the mounting portion so that the push rod mechanism can drive the movable contact piece to move to come into contact with or separate from the contact terminal; the lead-out terminal extends out from a bottom surface of the base and is used for electrical connection with an external circuit; a width of the lead-out terminal is smaller than a width of the contact terminal.

17. The relay according to claim 16, the static contact piece is inserted into the base along an insertion direction, the insertion direction is perpendicular to both a movement direction of the push rod mechanism and a length direction of the movable contact piece.

18. The relay according to claim 17, an extension direction of the lead-out terminal is parallel to the insertion direction.

19. The relay according to claim 16, the static contact piece comprises two lead-out terminals, both of the two lead-out terminals extend out from the bottom surface of the base, and an extension direction of each lead-out terminal is perpendicular to a movement direction of the push rod mechanism.

20. The relay according to claim 19, the two lead-out terminals are arranged side by side along a length direction of the movable contact piece.

21. The relay according to claim 16, the contact assembly comprises multiple sets arranged sequentially along a movement direction of the push rod mechanism.

22. The relay according to claim 16, the base has a mounting hole that penetrates an inner surface and a bottom surface of the base, a wall of the mounting hole has a positioning wall structure and a gap wall structure;
the static contact piece is inserted through the mounting hole, and part of outer wall surface of the static contact piece abuts against the positioning wall structure, while another part of outer wall surface of the static contact piece has a gap with the gap wall structure, the gap is filled with positioning glue.

23. The relay according to claim 22, the static contact piece is in interference fit with the positioning wall structure.

24. The relay according to claim 22, the positioning wall structure comprises a first positioning wall and a second positioning wall arranged oppositely along a positioning direction.

25. The relay according to claim 22, the static contact piece comprises two lead-out terminals, both of the two lead-out terminals extend out from the bottom surface of the base, and an extension direction of each lead-out terminal is perpendicular to a movement direction of the push rod mechanism,
the base has two mounting holes corresponding two lead-out terminals, and the two lead-out terminals are inserted through the two mounting holes, respectively, each lead-out terminal abuts against the positioning wall structure of corresponding mounting hole and has a gap with the gap wall structure.

26. The relay according to claim 16, the external circuit comprises a circuit board, and the lead-out terminal is soldered to the circuit board.
